(19) United States
(12) Patent Application Publication
(10) Pub. No.: US 2025/0219155 A1
(43) Pub. Date: Jul. 3, 2025

(54) ELECTROCHEMICAL CELL INCLUDING AN ADDITIVE AND METHOD OF OPERATING THE ELECTROCHEMICAL CELL

(71) Applicant: Form Energy, Inc., Somerville, MA (US)

(72) Inventors: Zachariah Norman, Somerville, MA (US); Michael Gibson, Somerville, MA (US); Annelise Thompson, Somerville, MA (US); Leah Nation, Cambridge, MA (US); Rebecca Eisenach, Cambridge, MA (US); Iskander Douair, Northbridge, MA (US)

(73) Assignee: Form Energy, Inc., Somerville, MA (US)

(21) Appl. No.: 19/001,934

(22) Filed: Dec. 26, 2024

Related U.S. Application Data
(60) Provisional application No. 63/615,386, filed on Dec. 28, 2023.
(60) Provisional application No. 63/703,397, filed on Oct. 4, 2024.

(51) Int. Cl. H01M 10/26; H01M 4/02; H01M 4/52; H01M 10/44

(52) U.S. Cl. CPC H01M 10/26; H01M 4/521; H01M 10/446; H01M 2004/021; H01M 2004/027

(57) ABSTRACT

An electrochemical cell including: a first electrode including iron, wherein a density (D) of the iron in the first electrode is greater than 2.11 g/cm³ and less than 7.87 g/cm³, based on a total weight of the iron and a total volume of the first electrode; an alkaline electrolyte; a second electrode; and an additive comprising a metal M, wherein the additive is effective to facilitate oxidation of the iron to Fe₃₋ₓMₓO₄, wherein 0≤x<1, and wherein a specific discharge capacity (Q) of the first electrode in the first discharge plateau is represented by Formula 1:

Q>((7.87/D)−1)*352 mAh/gram of iron, based on a total weight of iron in the first electrode (1).

### CROSS REFERENCE TO RELATED APPLICATIONS

This application claims priority to U.S. Provisional Application No. 63/615,386 filed on Dec. 28, 2023, and U.S. Provisional Application No. 63/703,397 filed on Oct. 4, 2024, and all the benefits accruing therefrom under 35 U.S.C. § 119, the content of both of which are incorporated by reference herein in their entirety.

### BACKGROUND

Batteries help solve the problem of discontinuous production of electrical energy and allow for storage of electrical energy when the electricity supply does not match electricity demand. Iron-air rechargeable batteries are a promising technology for energy storage. Iron-air batteries leverage low-cost materials, e.g, iron and oxygen from ambient air, to reversibly store energy, There remains a continuing need for improved iron-air batteries.

### SUMMARY

Disclosed is an electrochemical cell comprising an additive that is effective to facilitate oxidation of iron to Fe₃₋ₓMₓO₄, wherein 0≤x<1. Also disclosed is a tin-iron compound, a negative electrode including the tin-iron compound, an electrochemical cell including the negative electrode, a battery including the electrochemical cell, a system including the battery, and a method of producing the tin-iron compound. Also disclosed is a method of operating the electrochemical cell to reversibly oxidize and reduce iron to and from Fe₃₋ₓMₓO₄, wherein 0≤x<1.

Disclosed is an electrochemical cell including: a first electrode including iron, wherein a density (D) of the iron in the first electrode is greater than 2.11 g/cm³ and less than 7.87 g/cm³, based on a total weight of the iron and a total volume of the first electrode; an alkaline electrolyte; a second electrode; and an additive including a metal M, wherein the additive is effective to facilitate oxidation of the iron to Fe₃₋ₓMₓO₄, wherein 0≤x<1, optionally 0<x<1, and wherein a specific discharge capacity (Q) of the first electrode in the first discharge plateau is represented by Formula 1

Q>((7.87/D)−1)*352 mAh/gram of iron, based on the total weight of iron in the first electrode (1).

Also disclosed is an electrochemical cell including: a first electrode including iron, wherein a density (D) of the iron in the first electrode is greater than 2.11 g/cm³ and less than 7.87 g/cm³, based on a total weight of iron and a total volume of the first electrode, wherein the first electrode includes Fe₃₋ₓMₓO₄, wherein M is a metal and 0≤x<1, optionally 0<x<1; an alkaline electrolyte; a second electrode; and wherein a specific discharge capacity (Q) of the first electrode in the first discharge plateau is represented by Formula 1

Q>((7.87/D)−1)*352 mAh/gram of iron, based on the total weight of iron in the first electrode (1).

Also disclosed is an electrochemical cell including: a first electrode including iron, wherein a density of the iron in the first electrode is less than 2.11 g/cm³, based on a total weight of the iron and a total volume of the first electrode; an alkaline electrolyte; a second electrode; and an additive including a metal M, wherein the additive is effective to facilitate oxidation of the iron to Fe₃₋ₓMₓO₄, wherein 0≤x<1, optionally 0<x<1, and wherein a specific discharge capacity of the first electrode in the first discharge plateau is greater than 960 mAh/gram of iron, based on the total weight of iron in the first electrode.

Also disclosed is an electrochemical cell including: a first electrode including iron, wherein a density of the iron in the first electrode is less than 2.11 g/cm³, based on a total weight of the iron and a total volume of the first electrode, and wherein the first electrode includes Fe₃₋ₓMₓO₄, wherein M is a metal and 0≤x<1, optionally 0<x<1; an alkaline electrolyte; and a second electrode, wherein a specific discharge capacity of the first electrode in a first discharge plateau of the electrochemical cell is greater than 960 mAh/gram of iron, based on a total weight of iron in the first electrode.

Also disclosed is a method of operating an electrochemical cell, the method including: providing an electrochemical cell including a first electrode including iron, an alkaline electrolyte, and a second electrode, wherein the alkaline electrolyte, the first electrode, or a combination thereof includes an additive including M wherein M is a metal, the additive effective to facilitate oxidation of the iron to Fe₃₋ₓMₓO₄, wherein 0<x<1, optionally 0<x<1, on a first discharge plateau; discharging the electrochemical cell at a C rate of less than C/12, preferably C/150 to C/12, to oxidize the iron and form the Fe₃₋ₓMₓO₄ wherein 0≤x<1; and charging the electrochemical cell to operate the electrochemical cell.

Also disclosed is a method of operating an electrochemical cell, the method including: providing the electrochemical cell including a first electrode including iron, an alkaline electrolyte, and a second electrode, wherein the alkaline electrolyte, the first electrode, or a combination thereof includes an additive including M, wherein M is a metal; discharging the electrochemical cell at a C rate of less than C/12, preferably C/150 to C/12, to concurrently oxidize the iron to iron (II) hydroxide and the iron (II) hydroxide to Fe₃₋ₓMₓO₄ wherein 0≤x<1, optionally 0<x<1, on a first discharge plateau; and charging the electrochemical cell to operate the electrochemical cell.

Also disclosed is an electrochemical method to produce a tin-iron compound, the method including: providing an electrochemical cell including: a first electrode including iron, an alkaline electrolyte, a second electrode, and an additive including tin; and discharging the electrochemical cell to oxidize the iron of the first electrode and produce the tin-iron compound, wherein the tin-iron compound includes tin, iron, and oxygen, and the tin-iron compound has a formula of Fe₃₋ₓSnₓO₄, wherein 0.01<x≤1.

Also disclosed is a tin-iron compound prepared by the method.

Also disclosed is a negative electrode for an alkaline electrochemical cell, the negative electrode including: a current collector; and a negative electrode active material layer including a negative electrode active material on the current collector, wherein the negative electrode active material includes a tin-iron compound including tin, iron, and oxygen, and the tin-iron compound has a formula of Fe₃₋ₓSnₓO₄, wherein 0.01<x≤1.

Also disclosed is an electrochemical cell including: the negative electrode; an alkaline electrolyte; and a positive electrode.

Also disclosed is a battery including the electrochemical cell.

Also disclosed is a system including the battery.

Also disclosed is an electrochemical cell including: a first electrode including iron; an alkaline electrolyte; a second electrode; and a tin-iron compound, wherein the tin-iron compound includes tin, iron, and oxygen, and the tin-iron compound has a formula of Fe₃₋ₓSnₓO₄, wherein 0.01<x≤1.

Also disclosed is a method of operating an electrochemical cell, the method including: providing the electrochemical cell including: a first electrode including iron, an alkaline electrolyte, a second electrode, and an additive including tin; discharging the electrochemical cell to oxidize the iron of the first electrode and produce a tin-iron compound, wherein the tin-iron compound has a formula of Fe₃₋ₓSnₓO₄, wherein 0.01<x≤1; and charging the electrochemical cell to convert at least a portion of the tin-iron compound to iron metal.

Also disclosed is an electrochemical method of producing a tin-iron compound, the method including: providing an electrochemical cell including: a first electrode including iron, an alkaline electrolyte, a second electrode, and an additive including tin; and discharging the electrochemical cell to produce the tin-iron compound, wherein the additive is contained in at least one of the first electrode, the alkaline electrolyte, or the second electrode, and wherein the tin-iron compound includes tin, iron, and oxygen, and the tin-iron compound has a formula of Fe₃₋ₓSnₓO₄, wherein 0.01<x≤1.

Also disclosed is an electrochemical method to produce a tin-iron compound, the method including: providing an electrochemical cell including: a first electrode including iron, an alkaline electrolyte, a second electrode, and an additive including tin having an oxidation state of 0, +2, +4, or a combination thereof; and discharging the electrochemical cell to produce the tin-iron compound, wherein the tin-iron compound includes a tin-doped magnetite, and the tin-doped magnetite has a cubic unit cell having a lattice parameter of greater than 8.399 Angstroms at 20° C., preferably from 8.410 to 8.595 Angstroms.

The above and other aspects and features are described and exemplified by the following figures and detailed description.

### BRIEF DESCRIPTION OF THE DRAWINGS

The following descriptions should not be considered limiting in any way.

FIG. 1 is a graph of iron utilization (milliampere-hours per gram of iron, mAh/g_{Fe}) versus density of iron in the negative electrode (grams of Fe per cm³) and shows the theoretical discharge limits for iron based on the discharge products Fe(OH)₂ and Fe₃O₄;

FIG. 2 is a graph of iron utilization (mAh/g_{F}e) versus density of iron in the iron negative electrode (grams of iron per cubic centimeter, g_{Fe}/cm³) showing the geometrically-constrained utilization of the iron electrodes;

FIG. 3 is a schematic representation of an embodiment of an electrochemical cell;

FIG. 4A is a graph of negative electrode voltage (Volts vs. a reversible hydrogen electrode (RHE)) versus specific discharge capacity (milliampere-hours per grams of iron, mAh/g_{Fe}) for Example 2 showing distinct iron reactions, with a primary discharge plateau between 0 and 0.02 volts vs RHE;

FIG. 4B is a graph of negative electrode voltage (volts vs. RHE) versus differential capacity (dQ/dV) for Example 2;

FIG. 4C is a graph of differential voltage (dV/dQ) versus specific discharge capacity (mAh/g_{Fe}) for Example 2;

FIG. 5 is a graph of voltage, crystalline fraction (“XtalFrac”) and phase fraction of Fe, Fe₃O₄, Fe(OH)₂, and delta-FeOOH vs. specific charge capacity (mAh/g) for an electrode including the additive (right) and an electrode without the additive (left), showing the results of in-situ operational synchrotron X-ray diffraction analysis;

FIG. 6 is a graph of voltage, crystalline fraction (“XtalFrac”) and phase fraction of Fe, Fe₃O₄, Fe(OH)₂, and delta-FeOOH vs. specific discharge capacity (mAh/g) for the electrode including the additive (right), and the electrode without the additive (left) of FIG. 7, showing the results of in-situ operational synchrotron X-ray diffraction analysis;

FIG. 7 is a histogram showing the electrode composition (weight percent (wt %), based on a total weight of the electrode) versus starting oxide in the powder blend (wt %) for the starting negative electrode and cycled negative electrode of Example 3;

FIG. 8 is a graph of cell voltage (V) versus specific discharge capacity (mAh/g) for the electrodes in Examples 1 to 4;

FIG. 9 is a graph of cell voltage (V) versus fraction of theoretical specific discharge capacity (arbitrary units, a.u.) for the electrodes in Examples 1 to 4 based on production of Fe(OH)₂;

FIG. 10 is a graph of magnetite lattice parameter (a) vs calculated mole fraction of tin in the negative electrode, showing magnetite lattice expansion upon tin incorporation; and

FIG. 11 is a graph of intensity (arbitrary units, a.u.) versus diffraction angle (°2θ), showing results of X-ray diffraction analysis of tin-iron compounds from Example 4.

### DETAILED DESCRIPTION

Iron batteries comprising iron-containing negative electrodes are promising because iron is an abundant, inexpensive, non-toxic, and economical material. An iron-air battery is an electrochemical cell (e.g., a plurality of connected electrochemical cells) that includes an iron negative electrode, a positive electrode that is exposed to air or oxygen, and an electrolyte, such as an aqueous alkaline electrolyte. During discharge of the iron-air battery, oxygen reduction occurs at the positive electrode and the iron negative electrode is oxidized. On charge, oxygen is evolved and the iron is reduced. Recently, interest in developing iron-air batteries has increased, due to iron-air batteries having the potential to provide grid-scale energy storage.

Half-cell reactions at the iron negative electrode (i.e., iron electrode) that can occur during discharge (iron oxidation) in an alkaline electrolyte in an iron-air cell are as provided by Equations 1 and 2:

$$Fe + 2 {OH}^{-} ⇆ {Fe ( OH )}_{2} + 2 {e}^{-} \qquad ( Equation 1 )$$

$$3 {Fe ( OH )}_{2} + 2 {OH}^{-} ⇆ {Fe}_{3} {O}_{4} + 4 {H}_{2} O + 2 {e}^{-} . \qquad ( Equation 2 )$$

While not wanting to be bound by theory, it is understood that as provided in Equation 1, on discharge iron hydroxide (Fe(OH)₂) forms on the surface of the iron electrode, and as provide in Equation 2, the iron hydroxide is understood to subsequently oxidize further to form magnetite (Fe₃O₄). The theoretical capacity, based on metallic iron (i.e., Fe⁰), is 960 milliampere-hours per gram (mAh/g) of iron in Equation 1, and 320 mAh/g of iron in Equation 2.

The Applicants have discovered that including an additive comprising a metal M in an electrochemical cell having an iron electrode, wherein the additive is effective to facilitate electrochemical oxidation of iron to Fe₃₋ₓMₓO₄ (0≤x<1), can surprisingly also improve the efficiency and cyclability of the electrochemical cell. While not wanting to be bound by theory, it is believed that in an iron-air battery, inclusion of the additive, e.g., Sn, can facilitate the conversion of Fe(OH)₂ provided by Equation 1 to magnetite via Equation 2, or to Fe₃₋ₓMₓO₄ (0<x<1), resulting in improved efficiency and cyclability of the cell. In an aspect, and again while not wanting to be bound by theory, it is understood that the presence of the additive unexpectedly improves the kinetics of Equation 2. Also, and further unexpected, it has been discovered that the additive can facilitate the reduction of magnetite or Fe₃₋ₓMₓO₄ (0<x<1), if present, to metallic iron, thus providing improved longevity or reversibility of an electrochemical cell comprising the additive. In an aspect, inclusion of a tin-iron compound having a formula of Fe₃₋ₓSnₓO₄, wherein 0<x<1, in an electrochemical cell surprisingly provides improved efficiency and cyclability.

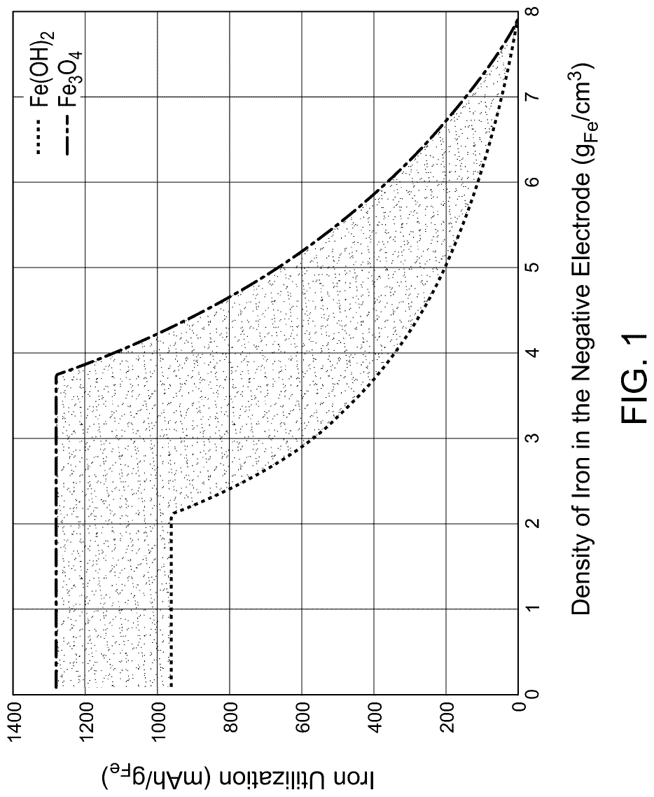

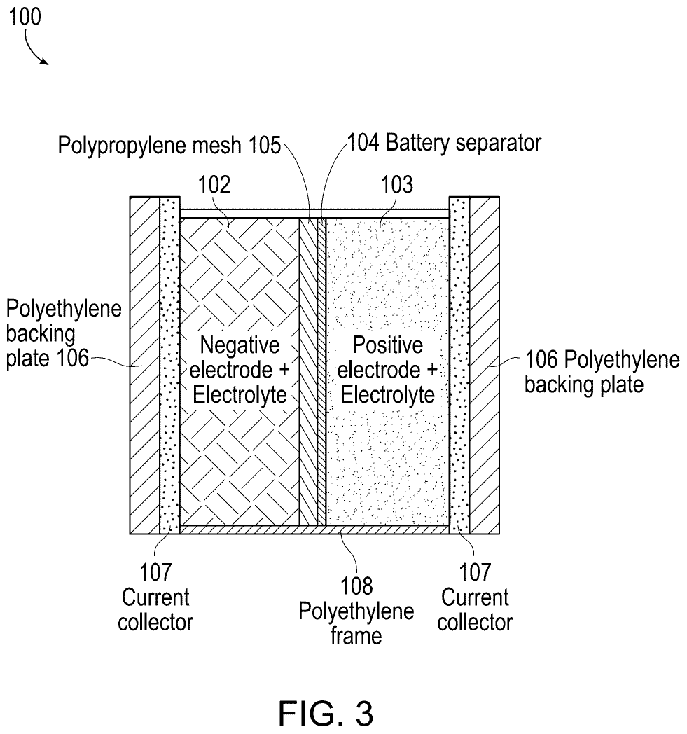

While not wanting to be bound by theory, the iron electrode undergoes phase transformations as define by Equations 1 and 2. Each phase has a different volume per mole of iron:metallic iron (0) has a volume of 7.09 cubic centimeters per mole of iron (cm³/mol_{Fe}), iron(II) hydroxide has a volume of 26.4 cm³/mol_{Fe}, and magnetite has a volume of 15.0 cm³/mol_{Fe}. The conversion of iron to oxides thus involves a volume expansion by a factor of 3.7 to 2.14 depending on the oxide product. In a porous electrode (e.g., a porous iron electrode), the expanded product is limited to filling a total pore volume of the electrode. Also while not wanting to be bound by theory, it is understood that a discharge capacity for conversion of an iron electrode from the metallic state to the oxide is limited by the total pore volume. An equation of a specific discharge capacity (Q)=((7.87/D)−1)*352 is based on the assumption that the total pore volume of the iron negative electrode is filled by an iron (II) hydroxide phase, corresponding to the reaction that is said to form on the first plateau of the iron discharge of the iron negative electrode in the academic literature. Specific discharge capacities greater than this value should not be possible on a single reaction plateau if the iron hydroxide phase is the only discharge product. An equation Q=((7.87/D)−1*1158.4 is based on the assumption that the total pore volume of the iron electrode is filled by the magnetite phase on discharge. Referring to FIG. 1, capacities above the line Q=((7.87/D)−1*352 and below the line Q=((7.87/D)−1*1158.4 therefore correspond to capacities that are only accessible through formation of at least a portion of the discharge product as direct conversion of magnetite (rather than solely iron hydroxide). The derivation of these equations comes from prior work on sintered cadmium and iron electrodes. See, for example, Selanger, P. Analysis of porous alkaline Cd-electrodes. III. The application of charge porosity diagrams in electrode design; or J. Appl. Electrochem. 4, 263-266 (1974), or W. A. Bryant 1979 J. Electrochem. Soc. 126 1899, the contents of both of which are incorporated by reference in their entirety. FIG. 3 of Bryant shows the theoretical capacity of iron and the discharge capacity of iron as a function of porosity according to the porosity model of Selånger.

An aspect provides an electrochemical cell comprising: a first electrode comprising iron, wherein a density (D) of the iron in the first electrode is greater than 2.11 g/cm³ and less than 7.87 g/cm³, based on a total weight of the iron and a total volume of the first electrode; an alkaline electrolyte; a second electrode; and an additive comprising a metal M, wherein the additive is effective to facilitate oxidation of the iron to Fe₃₋ₓMₓO₄, wherein 0≤x<1, and wherein a specific discharge capacity (Q) of the first electrode in the first discharge plateau is represented by Formula 1,

Q>((7.87/D)−1)*352 mAh/gram of iron (g_{Fe}), based on a total weight of iron in the first electrode (1).

Determination of the specific discharge capacity is based on discharging a charged electrochemical cell, and dividing the integrated current from discharge by the mass of iron in the first electrode.

The density (D) of the iron in the first electrode may be 2.11 to 7.87 g/cm³, 3 to 6 g/cm³, or 4 to 5 g/cm³, based on the total weight of iron in the first electrode and the total volume of the first electrode. In an aspect, the density (D) of iron in the first electrode is less than 3.74 g/cm³, preferably 2.11 to 3.5 g/cm³, or 2.2 to 3.2 g/cm³, based on the total weight of iron in the first electrode and the total volume of the first electrode.

In an aspect, the specific discharge capacity (Q) of the first electrode is less than 1280 mAh/g_{Fe}, or less than ((7.87/D)−1)*1158.4 mAh/g_{Fe}, based on the total weight of iron in the first electrode, and the specific discharge capacity (Q) of the first electrode is greater than ((7.87/D)−1)*352 mAh/g_{Fe}, based on the total weight of iron in the first electrode. Mentioned is when the specific discharge capacity is ((7.87/D)−1)*352 mAh/g_{Fe} to ((7.87/D)−1)*1158.4 mAh/g_{F}e. Also mentioned is when the specific discharge capacity is less than 1280 mAh/g_{Fe}, e.g., 920 to 1280 mAh/g_{Fe}, 960 to 1250 mAh/g_{Fe}, 1000 to 1200 mAh/g_{Fe}, or 1050 to 1150 mAh/g_{F}e. In an aspect, the specific discharge capacity of the first electrode and based on the iron is at least 90% of a total specific discharge capacity of the first electrode.

Alternatively, in an aspect, the electrochemical cell may be the same except that it does not comprise the additive comprising the metal M, and the first electrode comprises Fe₃₋ₓMₓO₄.

Alternatively, in an aspect, the electrochemical cell may be the same except that the density (D) of the iron in the first electrode is less than 2.11 g/cm³, based on the total weight of the iron and the total volume of the first electrode, and the specific discharge capacity of the first electrode in the first discharge plateau is greater than or equal to 960 mAh/g_{Fe}, based on the total weight of iron in the first electrode. For example, the density of the iron in the first electrode may be 1.85 to 2.11 g/cm³, 1.9 to 2.05 g/cm³, or 1.95 to 2 g/cm³, each based on the total weight of the iron and the total volume of the first electrode. The specific discharge capacity of the first electrode in the first discharge plateau may be 960 to 1280 mAh/g_{Fe}, 1000 to 1200 mAh/g_{Fe}, or 1050 to 1150 mAh/g_{Fe}, each based on the total weight of the iron in the first electrode. 960 mAh/g_{Fe} corresponds to the theoretical maximum capacity based on Fe⁰ oxidized to Fe(OH)₂, and 1280 mAh/g_{Fe} corresponds to the theoretical maximum capacity based on Fe⁰ oxidized to Fe₃O₄. Alternatively, in an aspect, the electrochemical cell may have the aforementioned density (D) and the specific discharge capacity (Q), but it does not comprise the additive comprising the metal M, and the first electrode comprises Fe₃₋ₓMₓO₄.

As used herein, the specific discharge capacity (Q), e.g., iron specific discharge capacity, refers to a discharge capacity of the first electrode divided by a weight of iron, based on a total weight of iron in the first electrode (mAh/g_{Fe}). The iron specific discharge capacity of the first electrode and attributable to the iron may be at least 80%, preferably 90%, 95%, 98%, or 99% to 99.9%, 99.95%, 99.99%, or 100% of a total specific discharge capacity of the first electrode. In an aspect, the total specific discharge capacity may refer to the sum of the capacity of the electroactive materials, e.g. including tin, in the first electrode.

In an aspect, the iron can be any form of iron and have any oxidation state, including an oxidation state of 0, 2+, 3+, or a combination thereof, with the proviso that the iron is not 100% Fe₃O₄ (Fe₃O₄ cannot be oxidized to Fe₃O₄). In an aspect, the iron is Fe⁰, and x of Fe₃₋ₓMₓO₄ is 0≤x<1. In an aspect, the iron is Fe(OH)₂, and x of Fe₃₋ₓMₓO₄ is 0≤x<1. In an aspect, the iron is Fe⁰, Fe(OH)₂, Fe₃O₄, or a combination thereof, and x of Fe₃₋ₓMₓO₄ is 0≤x<1. In an aspect, the iron is Fe⁰, Fe(OH)₂, Fe₃O₄, or a combination thereof, and x of Fe₃₋ₓMₓO₄ is 0<x<1, 0.001<x<0.5, or 0.01<x<0.1. The Fe₃O₄ can have any suitable structure and comprise any suitable phase. Magnetite is mentioned.

### Additive

In an aspect, the additive comprises the metal M, wherein the metal is Sn, Mo, W, Nb, Ta, Ge, Pb, Bi, Sb, Ti, Al, Zn, or a combination thereof. Mentioned is an aspect wherein the metal may be Sn, Al, or both. The metal may be Sn or Ge. In an aspect, the first electrode may comprise the additive, and a content of the additive in the first electrode is 0.5 to 25 weight percent (wt %), 1 to 15 wt %, 1.5 to 10 wt %, or 2 to 7 wt %, each based on a total weight of the first electrode. In an aspect, the alkaline electrolyte may comprise the additive, and a content of the additive in the alkaline electrolyte is 0.1 to 200 millimolar (mM), 10 to 150 mM, or 30 to 90 mM, each based on a total volume of the alkaline electrolyte.

The additive comprising the metal M, wherein the metal is Sn, Mo, W, Nb, Ta, Ge, Pb, Bi, Sb, Ti, Al, Zn, or a combination thereof, may be included as metallic Sn, metallic Mo, metallic W, metallic Nb, metallic Ta, metallic Ge, metallic Pb, metallic Bi, metallic Sb, metallic Ti, metallic Al, metallic Zn, or a combination thereof. The additive comprising the metal M may be included as a metal-containing compound, and the metal-containing compound may be a Sn, Mo, W, Nb, Ta, Ge, Pb, Bi, Sb, Ti, Al, or Zn-containing compound, or a combination thereof. A combination of at least one of the foregoing, e.g., metallic tin and a zinc-containing compound, may be used.

In an aspect, the additive comprises tin. The additive comprising tin may be included as metallic tin, as a tin-containing compound, or a combination thereof. Exemplary tin species include tin metal, sodium stannate trihydrate (Na₂SnO₃·3H₂O), potassium stannate trihydrate (K₂SnO₃·3H₂O), calcium stannate (CaSnO₃), magnesium stannate (MgSnO₃), barium stannate (BaSnO₃), cobalt stannate (Co₂SnO₄), tin oxide (SnO, or SnO₂), cylindrite (Pb₃Sn₄FeSb₂S₁₄), canfieldite (Ag₈SnS₆), copper iron tin sulfide (Cu₂FeSnS₄), a lead-tin alloy (such as 60/40 Sn/Pb solder, or 63/37 Sn/Pb solder, a Terne I alloy comprising 10-20% Sn, balance Pb), a zinc-tin alloy (such as a Terne II alloy comprising 10 to 20% Sn, balance Zn), tin chloride (SnCl₂), or tin sulfide (SnS or SnS₂).

In an aspect, the additive comprising tin comprises sodium stannate, potassium stannate, sodium stannate trihydrate, metallic tin, potassium stannate trihydrate, tin (II) oxide (SnO), tin (IV) oxide (SnO₂), cylindrite, copper iron tin sulfide, a lead-tin alloy, a zinc-tin alloy, iron tin oxide, tin sulfide, SnCl₂, tin sulfate (SnSO₄), or a combination thereof, preferably, sodium stannate, potassium stannate, or a combination thereof.

In an aspect, the additive comprising the metal M comprises the metal having an oxidation state of 0, +1, +2, +3, +4, or a combination thereof. For example, the additive comprising tin comprises tin having an oxidation state of 0, +2, +4, or a combination thereof. While not wishing to be bound by theory, it is understood that tin having an oxidation state of +2, such as tin (II) oxide, tin having an oxidation state of +4, such as tin (IV) oxide, tin having an oxidation state of 0, such as metallic tin, or a combination thereof, facilitate oxidation of the iron to the Fe₃₋ₓMₓO₄.

In an aspect, the additive comprising the metal M is contained in the first electrode, the alkaline electrolyte, or a combination thereof.

In an aspect, the first electrode further comprises the additive comprising the metal M, and an amount of the additive in the first electrode may be 0.5 to 25 wt %, 1 to 15 wt %, 1.5 to 10 wt %, or 2 to 7 wt %, based on a total weight of the first electrode.

In an aspect, the alkaline electrolyte comprises the additive comprising the metal M, and an amount of the metallic M, or M-containing compound in the alkaline electrolyte may be greater than 0.1 millimoles per liter (mM), for example, 0.1 to 200 mM, 10 to 150 mM, or 30 to 90 mM, based on a total volume of the alkaline electrolyte.

In an aspect, the alkaline electrolyte comprises the additive comprising the metal M, and an amount of the metallic M or M-containing compound in the alkaline electrolyte may be at or near a solubility limit of M-containing species in the alkaline electrolyte. A source of additional M may be placed in contact with the electrolyte such that upon formation of the Fe₃₋ₓMₓO₄, more M may be available to dissolve into the alkaline electrolyte. In this way, M may be functionally available in the electrolyte at levels exceeding the solubility limit of tin in the electrolyte.

### Iron Electrode Utilization

While not wanting to be bound by theory, it is understood that the first discharge plateau, also referred to as a high voltage plateau, corresponds to a region of the discharge capacity attributed to a combination reactions of Equation 1 and Equation 2, as can be shown in a graph of potential (V) vs. capacity (Q):

$$Fe + 2 {OH}^{-} ⇆ {Fe ( OH )}_{2} + 2 {e}^{-} and \qquad ( Equation 1 )$$

$$3 {Fe ( OH )}_{2} + 2 {OH}^{-} ⇆ {Fe}_{3} {O}_{4} + 4 {H}_{2} O + 2 {e}^{-} . \qquad ( Equation 2 )$$

It is understood that the thermodynamic potential for these reactions is a function of water activity, with each reaction having a different response to changes in water activity due to the stoichiometry of water in each reaction. Without being bound by theory, the inventors have unexpectedly discovered that in a concentrated caustic solution with a water activity in the range of 0.5 to 0.65, the thermodynamic potentials for the conversion of iron to iron hydroxide, and for iron hydroxide to magnetite, theoretically converge, which enables access to both products at technologically advantageous voltages during discharge. The high voltage plateau is thus defined as the region during discharge wherein the conversion of iron to iron(II) hydroxide and magnetite occurs, as determined by a phase sensitive characterization technique, e.g., X-ray diffraction spectroscopy, Raman spectroscopy, or the like.

Reactions to produce alternative Fe³⁺ products occur at other potentials relative to a hydrogen electrode. Products include γ-Fe₂O₃ (maghemite), δ-FeOOH (feroxyhyte), or α-Fe₂O₃ (hematite). Thus, the first discharge plateau of an iron electrode can be defined as the voltage wherein the primary products of iron oxidation are Fe(OH)₂ (iron(II) hydroxide) and Fe₃O₄ (magnetite), and other iron oxide products are substantially absent.

Table 1 provides standard state Gibbs free energy and reduction potentials for various iron oxide half reactions at varying values of water activity (a_{w}).

TABLE 1
Iron Oxide Half Reactions

| | | ΔG° | E° (V vs RHE) | E° (V vs RHE) |
|---|---|---|---|---|
| # | Half Reaction | (kJ/mol) | 25° C., a_{w} = 1.00 | 25° C., a_{w} = 0.61 |
| 1 | Fe(OH)₂ + 2H⁺ + 2e− ⇄ Fe + 2H₂O | 17.7 | −0.09 | −0.08 |
| 2 | Fe₃O₄ + 8H⁺ + 8 e⁻ ⇄ 3Fe + 4H₂O | 64.1 | −0.0831 | −0.0768 |
| 3 | Fe₃O₄ + 2H⁺ + 2e− + 2H₂O ⇄ 3Fe(OH)₂ | 11.0 | −0.06 | −0.07 |
| 4 | γ-Fe₂O₃ + 2H⁺ + 2e− + H₂O ⇄ 2Fe(OH)₂ | −19.0 | 0.10 | 0.09 |
| 5 | δ-FeOOH + H⁺ + e⁻ ⇄ Fe(OH)₂ | −10.0 | 0.10 | 0.10 |
| 6 | 3 α-Fe₂O₃ + 2 H⁺ + 2 e⁻ ⇄ 2 Fe₃O₄ + H₂O | −29.3 | 0.15 | 0.16 |

The potential of the first discharge plateau may be an iron negative electrode voltage of −0.1 V vs. RHE to 0.1 V vs RHE:
i) when the cycling (i.e., charge or discharge) rate of the cell is 0.001 or 0.01 mAh/g to <10 mA/g, <7 mA/g, <3 mA/g, <1.5 mA/g, or <0.5 mA/g,
ii) when the charge or discharge rate of the cell is 0.001 or 0.01 mAh/cm² to 50 mA/cm², 30 mA/cm², 10 mA/cm², 5 mA/cm², or 1 mA/cm²,
iii) when the discharge duration is 10 to 1000 hours, 50 to 500 hours or 100 to 250 hours, e.g., 10 hours, 50 hours, 100 hours, or 1000 hours,
iv) wherein the rate of the discharge exceeds the self-discharge rate of the cell, or
v) a combination thereof.

The cell voltage of the first discharge plateau of an iron/air battery cell is dependent on the performance of the oxygen electrode (positive electrode), which depends on the properties of the electrode, the catalyst, and the concentration of oxygen supplied to the electrode. The cell voltage is also dependent on the conductivity of the electrolyte, the geometry of the cell, the thickness of the iron electrode, and the porosity of the iron electrode.

Using a high-performance gas diffusion electrode, atmospheric air at 1 atmosphere, and depending on the iron negative electrode thickness, a cell voltage above 0.75 V, above 0.70 V, above 0.65 V, or above 0.60 V, e.g., a cell voltage of 0.6, 0.65, or 0.7 to 0.85, 0.9, or 1.06 V volts, may correspond to the first discharge voltage plateau. The iron electrode thickness may be greater than 2.5 millimeters (mm), greater than 5 mm, greater than 10 mm, or greater than 15 mm. In an aspect, the iron electrode thickness is 2.5 to 100 mm, 3 to 80 mm, 4 to 60 mm, or 5 to 30 mm. Higher discharge rates correspond to lower cell voltages depending on the ohmic resistance of the cell and interfacial resistances.

The potential of the first discharge plateau may be determined from a peak in a graph of differential capacity (dQ/dV) versus potential (V). The potential of the first discharge plateau may correspond to the first peak (e.g., the most negative Fe peak) in the graph of dQ/dV versus V with capacity in excess of 50 mAh/g and below −0.9 V vs. a mercury-mercuric oxide (MMO) electrode. This potential can be used to determine the region of the discharge capacity corresponding to the first discharge plateau in the graph of voltage versus specific capacity.

A Kernel Density Estimator (KDE) can be used to estimate the probability density associated with each potential in a plot of potential (V) versus capacity (Q). The peaks in a plot of density versus voltage may be identified as individual reaction plateaus that may represent multiple reactions taking place within a range of potential. The local minima between these peaks can be selected to identify the start and end of a reaction plateau. Alternatively, the voltage where the density of a peak drops to 10% can be used to mark the end of a plateau. The first discharge plateau may be identified as the first and most negative plateau found by the following method below −0.9 V vs. MMO with a capacity in excess of 50 mAh/g. The charge/discharge rate when determining the first discharge plateau may be any suitable rate and having any suitable duration, and can be
i) 0.001 or 0.01 mAh/g to <10 mA/g, <7 mA/g, <3 mA/g, <1.5 mA/g, or <0.5 mA/g,
ii) when the charge/discharge rate of the cell is 0.001 or 0.01 mAh/cm² to <50 mA/cm², <30 mA/cm², <10 mA/cm², <5 mA/cm², or <1 mA/cm²,
iii) when the discharge duration is 10 to 1000 hours, e.g., 10 hours, 50 hours, 100 hours, or 1000 hours,
iv) where the rate of the discharge exceeds the self-discharge rate of the cell,
or
v) a combination thereof.

To facilitate or accelerate oxidation of the iron having an oxidation state less than an oxidation state of iron in Fe₃₋ₓMₓO₄ herein means to
a) provide a greater content of Fe₃₋ₓMₓO₄ than without the additive,
b) provide an oxidation rate greater than without the additive,
c) provide oxidation at a potential less than without the additive, or
d) a combination thereof.

In particular, the Applicants have surprisingly found that inclusion of the additive comprising M in the electrochemical cell facilitates oxidation of the iron to Fe₃₋ₓMₓO₄, wherein 0≤x<1. In an aspect, x=0. In an aspect, x may be 0<x<1, 0.01<x<0.8, 0.05<x<0.6, 0.1<x<0.5, or 0.2<x<0.4.

Without wanting to be bound by theory, the inventors have found that the inclusion of certain elements, such as Sn, in atomistic modeling calculations of the conversion of iron (II) hydroxide to magnetite lowers the activation energy barrier to oxidation. To elucidate the mechanism of stannate during the battery discharge process, computational chemistry experiments were conducted at the quantum level using Density Functional Theory (DFT) with the hybrid functional B3PW91. The Fe atom was modeled using a small-core Stuttgart-Dresden relativistic effective core potential (ECP) coupled with its corresponding basis set, while Sn, O, and H atoms were described using the 6-31G(d,p) basis set of double-(quality. Geometry optimizations were performed without symmetry constraints, and the nature of the stationary points was confirmed through analytical frequency calculations.

Enthalpy calculations were conducted using 298 K. The results indicated that stannate uniquely influences the dissolution process of Fe^{II}(OH)₂ into Fe^{III}(OH)₃, through the following steps:

Fe^{II}(OH)₂+Sn(OH)₆²⁻→Fe^{II}(OH)₃Sn(OH)₅²⁻→Fe^{III}(OH)₃Sn(OH)₅¹⁻.

These steps allow the transformation to be exothermic, providing −107 kilocalories per mole (kcal/mol). In the absence of Sn, a 45 kcal/mol endothermic process is observed. While not wanting to be bound by theory, the thermodynamic shift may drive formation of magnetite, enhancing the discharge capacity of the battery. Transition state analyses demonstrated that stannate significantly lowers the energy barrier for the dissolution process by 6 kilocalories per mole (kcal/mol) improving the reaction's feasibility at room temperature, e.g., 20° C. While not wanting to be bound by theory, the first discharge plateau of the iron electrode can be attributed to the reaction of Fe with hydroxide to form Fe(OH)₂ according to Equation 1. With sufficient acceleration of the oxidation of Fe to Fe₃O₄, the first discharge plateau of the iron electrode can be attributed to Equation 1 and Equation 2:

$$Fe + 2 {OH}^{-} \to {Fe ( OH )}_{2} + 2 {e}^{-} \qquad ( Equation 1 )$$

$$3 {Fe ( OH )}_{2} + 2 {OH}^{-} ⇆ {Fe}_{3} {O}_{4} + 4 {H}_{2} O + 2 {e}^{-} . \qquad ( Equation 2 )$$

A molar volume per-iron-atom of Fe(OH)₂ is about 370% greater than a molar volume per-iron-atom of metallic iron. As such, it may be desirable for the iron electrode to have a suitably low density (or a suitably high porosity) to accommodate the iron discharge product.

When determining the specific discharge capacity, the specific discharge capacity is often determined assuming that 100% of a total porosity (e.g., porosity) of the iron electrode is filled with Fe(OH)₂, and a fraction of the metallic iron that would need to be oxidized to achieve this 100% filling of the total porosity with Fe(OH)₂ is calculated. In an aspect, the total porosity may be measured by the BET method. The BET method is described in Brunauer, Stephen; Emmett, P. H.; Teller, Edward (1938), “Adsorption of Gases in Multimolecular Layers,” Journal of the American Chemical Society. 60 (2): 309-319, the content of which is incorporated herein by reference in its entirety. However, 100% filling of the total porosity may not be physically realizable in practice, for example because crystals do not precipitate from solution with 100% packing efficiency in the pore space. For example, discharge products, e.g., Fe(OH)₂ or Fe₃O₄, of the iron electrode may form randomly-oriented porous deposits. Thus determination of the maximum possible specific discharge capacity that an iron electrode can provide would be expected to exceed the actual specific discharge capacity because of imperfect packing efficiency in actual materials. Thus those skilled in the art would expect actual specific discharge capacity of the iron electrode for which the total porosity has been measured to be less than a specific discharge capacity calculated based on an assumption of 100% filling of the pores in the iron electrode with Fe(OH)₂.

Furthermore, porosities of as-fabricated electrodes having different starting materials, e.g., having different oxidation states, may be difficult to compare. For example, if an electrode is fabricated from an iron oxide, it will appear to have a low porosity. After charging the electrode, and attendant reduction of the oxidized species to iron metal, the electrode will gain porosity due to conversion of a higher-molar-volume oxide phase to a lower-molar-volume oxide or metal phase. To compare iron electrodes comprising iron having different oxidation states, normalization using volumetric charge density (i.e., a charge stored for a given volume of electrode) can be used. A density of iron in any oxidation state per unit volume of the electrode (expressed in g_{Fe}/cm³) can be defined, and the specific discharge capacity (expressed in mAh/g_{Fe}) for a given density of iron can be calculated.

The maximum utilization of a porous metal conversion electrode comprising iron can be determined analytically by considering the density of the active metal within the electrode to the density of the pure metal and the density of the target oxide phase using Equation 3:

$$U = \frac{{ρ}_{m}}{{ρ}_{e}} ( \frac{( {ρ}_{o} n F )}{s {ρ}_{m} {m}_{o} - {ρ}_{o} {m}_{m}} ) \qquad ( 3 )$$

where U, ρₘ, ρₑ, ρₒ, mm, mo, n, s, and F represent the maximum utilization in mAh/g, the pure metal density, the density of the metal per cubic cm in the electrode, the density of the pure oxide, the molar mass of the pure metal, the molar mass of the pure oxide, the number of electrons yielded per reaction turnover, the reciprocal of the number of metals per oxide formula unit, and Faraday's constant in units of mAh/mol, respectively. Values for iron oxides are given in Table 2.

TABLE 2

| Product | ρₘ | ρₒ | mₘ | mₒ | s | n |
|---|---|---|---|---|---|---|
| Unit | g/cm³ | g/cm³ | g/mol | g/mol | — | — |
| Fe(OH)₂ | 7.874 | 3.4 | 55.84 | 89.86 | 1 | 2 |
| Fe₃O₄ | 7.874 | 5.17 | 55.84 | 231.5 | ⅓ | 8/3 |

The applicants unexpectedly discovered that when the electrochemical cell comprises the aforementioned additive, in particular, with sulfide and potassium hydroxide, the volumetric charge density of the iron electrode may be greater than the maximum theoretical charge density of an iron electrode based on the conversion of Fe to Fe(OH)₂.

In an aspect, the volumetric charge density of the electrochemical cell comprising the additive can exceed the theoretical maximum when calculated based on conversion of Fe⁰ to Fe(OH)₂ in the pore space of the iron electrode. While not wanting to be bound by theory, it is understood that the additive comprising the metal M (e.g., Sn) facilitates the oxidation of the iron to Fe₃₋ₓMₓO₄ (0<x<1, optionally 0<x<1), e.g., Fe₃O₄, Fe₃₋ₓSnₓO₄, or a combination thereof, which has a molar volume per-iron-atom less than that of the Fe(OH)₂. In an aspect, the facilitating of the oxidation of the iron to Fe₃₋ₓMₓO₄ can be by a direct conversion of metallic iron to Fe₃₋ₓMₓO₄, or by conversion of metallic iron to Fe(OH)₂ and then conversion of Fe(OH)₂ to Fe₃₋ₓMₓO₄. While not wishing to be bound by theory, the additive may facilitate the reversible interconversion of Fe(OH)₂ to Fe₃O₄ by acting as a catalyst to the dissolved Fe(OH)₃⁻ ions believed to be central to the dissolution-precipitation mechanism. Additionally, the additive may act as a dopant in Fe(OH)₂, improving the electrical conductivity of the electrically resistive Fe(OH)₂ layer.

Without wanting to be bound by theory, the inventors have also discovered that other species other than tin are effective as an additive for activating the reversible conversion of iron. Tin is believed to both improve the conductivity of iron(II) hydroxide and magnetite as well as improve their structural stability. Using the methods of density functional theory as described above, the inventors have unexpectedly discovered that Mo, W, Nb, Ta, Ge, Pb, Bi, Sb, Ti, Zn, or a combination thereof, can also provide this functionality in the iron, iron(II) hydroxide, and magnetite system. Of these, Mo, W, Nb, or Ta computationally perform more effectively than Sn by improving the density of states at the Fermi level and decreasing the crystal energy.

Without wanting to be bound by theory, it is understood that for these elements to be effective as accelerating agents in the iron system, it is preferable to dissolve them in the electrolyte solution. Some materials have sufficient solubility on their own to be effective. Others may need to have their solubility enhanced. Organic additives or chelating agents, such as acetic acid, citric acid, succinic acid, ethylene diamine tetraacetic acid, 1,2 dihydroxybezene, disodium 4,5-dihydroxy-1,3-benzenedisulfonate (tiron), sucrose, or triethanolamine may enhance the solubility of the Sn, Mo, W, Nb, Ta, Ge, Pb, Bi, Sb, Ti, or Zn, which may not be otherwise evident from the element alone.

FIG. 1 shows the theoretical iron utilization, e.g., the iron specific discharge capacity of the negative electrode based on the quantity of discharge product which should fit in the pore space of the iron electrode, versus the density of iron in the negative electrode. FIG. 1 illustrates the maximum iron utilization based on the theoretical discharge capacity for iron for the discharge products Fe(OH)₂ and Fe₃O₄. The region between the Fe(OH)₂ and Fe₃O₄ curves represents the range of iron specific capacity for iron electrodes wherein at least of portion of the discharge product is Fe₃O₄, and is not solely Fe(OH)₂.

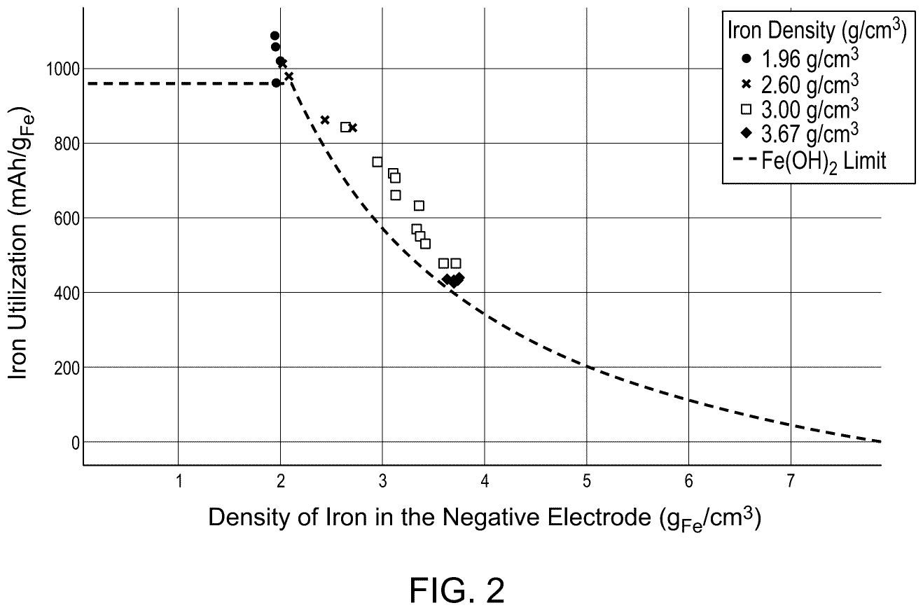

Actual packing density is expected to be less than theoretical. When realistic packing densities (e.g., 75% packing density in the pore space) are taken into account, the electrode materials are expected to provide significantly less specific capacity for a given porosity or density of iron. The inventors have surprisingly achieved utilization significantly above what should be possible based on the electrode-level porosity for an otherwise identical battery except for an absence of the additive, as shown in Table 3 and in FIG. 2. FIG. 2 shows the iron specific discharge capacity of the iron negative electrode versus the density of iron in the negative electrode, relative to the theoretical specific discharge capacity of the iron electrode when iron oxidizes to form Fe(OH)₂. Notably, as shown in Table 3, the inventors disclose geometrically-constrained utilization that appears to exceed the theoretical utilization of the iron electrode's high voltage reaction (i.e., the reaction corresponding to the first discharge plateau), and is significantly greater than what should be geometrically possible based on forming Fe(OH)₂ in the pore space.

TABLE 3

| | Upper utilization | Upper utilization | |
|---|---|---|---|
| Iron | limit assuming 75% | assuming 100% | Observed |
| Density | packing of Fe(OH)₂ | packing of Fe(OH)₂ | Utilization |
| (g/cm³) | (mAh/g) | (mAh/g) | (mAh/g) |
| 1.96 | 725 | 960 | 1087 |
| 2.60 | 490 | 715 | 842 |
| 3.00 | 392 | 570 | 750 |
| 3.67 | 275 | 400 | 478 |

Table 3 provides results relative to various bounds on iron electrode properties based on the Fe⇄Fe(OH)₂ reaction versus the direct conversion of Fe to Fe₃O₄. This relationship is shown for two packing densities of the discharge products in the pore space, a) 100 vol % packing density, and b) 75 vol % packing density in the pore space. The results in Table 3 are within 1% of the theoretical maximum for the Fe⇄Fe(OH)₂ reaction without excluding the volume of the additive when in a solid form. Because the solid additive and impurities in the electrode occupy space and displace iron, the density of iron should be less than what would be expected from a pure iron electrode. Thus the results in Table 3 appear to exceed the theoretical maximum when corrected for the volume of the solid additive.

Such compact iron electrodes having greater density and improved volumetric discharge capacity may be advantageous for more compact batteries, having reduced cost, improved durability, and improved manufacturability.

### Other Effects

In an aspect, the Fe₃₋ₓMₓO₄ is reversibly reducible to the iron (i.e., metallic iron) upon charging the electrochemical cell. The Fe₃₋ₓMₓO₄ is reversibly reducible to the iron and an M-containing species when M is present upon charging the electrochemical cell. The Fe₃₋ₓMₓO₄ may be disposed in a pore of the first electrode. Applicants have surprisingly observed that when the electrochemical cell comprises the additive comprising the metal M, the additive is effective to facilitate oxidation of the iron to Fe₃₋ₓMₓO₄, wherein 0≤x<1, and further, the formed Fe₃₋ₓMₓO₄ may be reversibly reduced to the iron by charging the electrochemical cell. This reversibility is unexpected because a discharge product, e.g., Fe₃O₄, of an iron-air battery is known to build up upon continued discharge and charge of the iron-air battery. The build-up of Fe₃O₄ results in decreasing discharge capacity over time and decreasing cyclability of the battery. To the contrary, the instant disclosure demonstrates improved cyclability over 10 to 200 cycles, in an aspect, 30 to 180 cycles, 50 to 150 cycles, 80 to 120 cycles at 30 to 45° C. when cycled galvanostatically at 5 to 20 mA/cm², e.g., 5, 7, 10, 15, or 20 mA/cm².

The additive comprising M is understood to facilitate oxidation and reduction of iron or an iron-containing compound, resulting in improved performance. The iron-air cell may have one or more of an improved coulombic efficiency, an improved energy efficiency, an improved voltaic efficiency, an improved specific discharge capacity, a reduced hydrogen evolution, or a combination thereof, relative to a same iron-air cell without the additive comprising M.

Fe₃₋ₓMₓO₄

In an aspect, as mentioned above, the first electrode may comprise Fe₃₋ₓMₓO₄. When the first electrode comprise the Fe₃₋ₓMₓO₄, the electrochemical cell may or may not comprise the additive comprising the metal M. For example, the first electrode as-prepared may comprise the Fe₃₋ₓMₓO₄, and the electrochemical cell comprising the aforementioned first electrode may or may not comprise the additive comprising the metal M. In another aspect, the Fe₃₋ₓMₓO₄ may be an oxidation product of the iron and may be formed on discharge of the electrochemical cell in the presence of the additive comprising M. The Fe₃₋ₓMₓO₄ may be a product of the metallic iron in the first electrode being oxidized to Fe₃₋ₓMₓO₄ on a discharge after the first discharge, such as on a second discharge or tenth discharge.

When the first electrode comprises Fe₃₋ₓMₓO₄, the alkaline electrolyte, the first electrode, or a combination thereof may further comprise the additive comprising the metal M. In an aspect, when the first electrode comprises the metal M, the first electrode may comprise the additive comprising tin. The additive comprising tin may be disposed within the first electrode, or may be disposed on a surface of the first electrode. In an aspect, the first electrode may further comprise the additive comprising tin, and a content of the additive comprising tin in the first electrode is 0.5 to 25 wt %, 1 to 15 wt %, 1.5 to 10 wt %, or 2 to 7 wt %, based on a total weight of the first electrode.

An aspect provides a negative electrode for an alkaline electrochemical cell, the negative electrode comprising: a current collector; and a negative electrode active material layer comprising a negative electrode active material on the current collector, wherein the negative electrode active material comprises Fe₃₋ₓMₓO₄. The negative electrode active material may optionally comprise additional iron-containing compounds that do not comprise M.

The Fe₃₋ₓMₓO₄ may be incorporated in the negative electrode active material when assembling the negative electrode, or the negative electrode comprising metallic iron may be assembled into an electrochemical cell, and the Fe₃₋ₓMₓO₄ may be formed by discharging the electrochemical cell to oxidize the metallic iron of the negative electrode.

In the negative electrode, the Fe₃₋ₓMₓO₄ may have a M content of 0.5 to 25 wt %, 5 to 20 wt %, or 10 to 15 wt %, based on a total weight of the negative electrode; or a M content of 0.5 to 25 wt %, 5 to 20 wt %, or 10 to 15 wt %, based on a total weight of the Fe₃₋ₓMₓO₄. In the negative electrode, for example Fe₃₋ₓSnₓO₄ may have a tin content of 1 to 25 wt %, 5 to 20 wt %, or 10 to 15 wt %, based on a total weight of the negative electrode; or a tin content of 1 to 25 wt %, 5 to 20 wt %, or 10 to 15 wt %, based on a total weight of the Fe₃₋ₓSnₓO₄.

### Cell Configuration and Components

An exemplary electrochemical cell according to an embodiment is shown schematically in FIG. 3. FIG. 3 illustrates the electrochemical cell 100, including a negative electrode 102 separated from a positive electrode 103 by the optional separator 104. Included is an alkaline electrolyte (for the negative electrode electrolyte and the positive electrode electrolyte) contacting the negative electrode, the positive electrode, and the optional separator. The separator 104 may be supported by a polypropylene mesh 105. The cell may comprise a polyethylene supporting frame 108. Optional current collectors 107 may be associated with the negative electrode 102 and positive electrode 103, respectively, and supported by a backing plate 106. The backing plate may be made of polyethylene, for example. The additive may be in the alkaline electrolyte, the negative electrode, or a combination thereof.

The alkaline electrolyte may be an aqueous solution, an ionic liquid, a gel, or a solid. The electrolyte may comprise any suitable hydroxide compound and have a pH greater than 10. The electrolyte may include, for example, an alkali hydroxide, an alkaline earth hydroxide, an organic hydroxide, or a combination thereof. In some embodiments, the electrolyte may include one or more of KOH, NaOH, LiGH, RbOH, CsOH, FrOH, Be(OH)₂, Ca(OH)₂, Mg(OH)₂, Sr(OH)₂, Ra(OH)₂, Ba(OH)₂, or a combination thereof, preferably KOH. A combination including at least one of the foregoing hydroxides may be used. In an aspect, the electrolyte may include KOH, NaOH, LiOH, or a combination thereof. The aqueous alkaline electrolyte comprises water.

In an aspect, the electrolyte includes KOH and NaOH, and a molar concentration of KOH may be greater than a molar concentration of NaOH, and the molar concentration of NaOH may be greater than a molar concentration of LiOH. In an aspect, the molar concentration of NaOH may be greater than the molar concentration of KOH. In still other aspects, a molar concentration of KOH and/or NaOH is greater than a molar concentration of LiOH.

In an aspect, the alkaline electrolyte has a total alkalinity of greater than 3 molar, preferably 3 to 12 molar, 4.5 to 8 molar, or 5.5 to 7 molar. In an aspect, a concentration of LiOH in the electrolyte is 0.01 to 0.1 molar, or 0.02 to 0.08 molar. As used herein, the term “total alkalinity” refers to the total concentration of hydroxide ions in the alkaline electrolyte as determined by a volumetric titration with a suitable acid to the first equivalence point. In an aspect, the total alkalinity may be determined according to ASTM D1067-16.

The first electrode comprising iron may be a negative electrode of the electrochemical cell and may be an anode on discharge. The first electrode, which may be referred to herein as the negative electrode or iron electrode may be a solid, and may be in a form of a non-porous or porous solid, a mesh, or a foam, and may be comprised of collection of particles. Use of an iron monolith is mentioned. As another example, the iron electrode may be a collection of particles in a suspension such that the particles are not buoyant enough to escape the suspension into the electrolyte.

In some embodiments, the iron electrode may be a porous iron-containing material. For example, the iron electrode may include metallic iron and/or various iron compounds, such as an iron oxide, hydroxide, sulfide, carbide, or a combination thereof. The iron-containing compounds may include any suitable form of iron, and may include a reduced (metallic) iron or an oxidized iron species having a higher average valence. The iron electrode may any suitable shape, and may be rectilinear or curvilinear, and may have a rectangular, cylindrical, or a spherical shape.

In some embodiments, the iron electrode may be formed from pelletized, briquetted, pressed, powdered, and/or sintered iron particles or particles of an iron-containing compound. Atomized, electrolytic, or sponge iron powders can be used as a feedstock material for forming a sintered iron electrode. For example, the iron electrode may include metallurgically-bonded sponge iron particles, such as direct reduced iron (DRI) or other sponge iron powder particles. The porosity of the sponge iron particles may be greater than 40 volume percent (vol %), and may be 50 to 99 vol %, 60 to 95 vol %, or 70 to 90 vol/%, based on a total volume of the iron particles. A particle size of the sponge iron particles may be greater than 1 micrometer (μm), and may be 1 to 10,000 μm, 10 to 5000 μm, or 50 to 800 μm.

The first electrode may be a product of heat treating a slurry, ink, suspension, or paste composition comprising the iron particles or iron compound and any other appropriate component and a fluid. Other components may include a conductive fiber or binder. The fluid may be water. The composition may be pressed, extruded, tape-cast, or otherwise processed to form a green body suitable for sintering to form an iron electrode. The binder may be a polymer, such as cellulose or poly(vinyl alcohol), or an inorganic clay. In an embodiment, a sintered iron agglomerate in the form of a pellet may be formed in a furnace, such as a continuous feed calcining furnace, batch feed calcining furnace, shaft furnace, rotary calciner, or a rotary hearth. The pellet may include any suitable form of reduced and/or sintered iron precursor, and may comprise Direct Reduced Iron (DRI), sponge iron powder, or an oxidation or reduction product thereof. The pellet, such as a DRI pellet, may be treated using an electrical, an electrochemical, a mechanical, a chemical, or a thermal process to provide a pellet suitable for use in an electrode for an electrochemical cell. The iron electrode may be a pressed plate electrode, a coated electrode, or a slip cast electrode, or may be manufactured using any suitable method known in the art for the manufacture of secondary storage electrodes.

In an aspect, the first electrode may further include a conductive material. The conductive material improves the conductivity of the iron electrode, may comprise a conductive metal or main group element, and may comprise tin, carbon, copper, silver, gold, a derivative thereof, or a combination thereof. The conductive material may be included in the first electrode to improve the conductivity of the first electrode. Mentioned is use of a conductive metal or metal element having an electrical resistivity of less than 125 nano-ohm-meters (nam).

In an aspect, a tin oxide, such a cassiterite ore or SnO₂, may be incorporated into an iron-containing composition for use in making the iron electrode. In an aspect, the tin oxide is incorporated into a composition for forming the DRI pellets such that it does not evaporate during the firing steps, and is then co-reduced with the iron oxides to yield a tin-containing sponge iron after the reduction process completes. In some embodiments, sodium, zinc, or manganese sulfide may also be added to an iron oxide powder that is reduced to form an iron oxide sponge containing sodium sulfide, zinc sulfide, or manganese sulfide. In some embodiments, materials containing multiple desired elements, e.g., cylindrite (PbSn₄FeSb₂S₁₄), or a combination of materials, may be incorporated into the iron composition prior to reduction. Mentioned is combining cassiterite and magnetite to form a composition prior to reduction to form the iron electrode.

The first electrode may further include a sulfide. Exemplary sulfides that may be included in the first electrode include Na₂S, FeS, SnS, SnS₂, MnS, or ZnS. A combination comprising at least one of the foregoing sulfides may be used.

The second electrode of the electrochemical cell is a positive electrode and may be a cathode on discharge. In an aspect, the second electrode is an air electrode. The air electrode may be an oxygen reduction reaction (ORR) electrode, an oxygen evolution reaction (OER) electrode, or both. The positive electrode may be any suitable electrode used as a positive electrode in the field.

The second electrode may include an electroconductive material, and a suitable catalyst disposed on the electroconductive material. The electroconductive material may be a carbonaceous material, a perovskite-type conductive material, a porous conductive polymer, a porous metal, or a combination thereof. The carbonaceous material may have a porous structure, or may lack a porous structure. Specific examples of the carbonaceous material having a porous structure include, for example, mesoporous carbon. Exemplary carbonaceous material lacking a porous structure include graphite, acetylene black, carbon nanotube, carbon fiber, or the like, or a combination thereof. Use of a non-woven carbon paper for the electroconductive material is mentioned.

The catalyst may be disposed on the electroconductive material. The catalyst may be effective for oxygen reduction, oxygen evolution, or both. The catalyst may include a platinum-group metal such as nickel, palladium, or platinum; a perovskite-type oxide that has a transition metal such as cobalt, manganese, or iron; an inorganic compound that is a noble metal oxide such as an oxide of ruthenium, iridium, or palladium; a metal containing coordination compound having a porphyrin skeleton or a phthalocyanine skeleton; or a manganese oxide or a cobalt oxide, such as La_{0.7}Sr_{0.3}CoO₃. In some embodiments, the catalyst may be a layered double hydroxide represented by a formula [M1²⁺₁₋ₓM2³⁺ₓ(OH)₂][Aⁿ⁻_{x/n·}yH₂O], where x is a real number that satisfies 0<x<1; y is a real number; M1²⁺ is a divalent metal ion such as Mg²⁺, Fe²⁺, Zn²⁺, Ca²⁺, Li²⁺, Ni²⁺, Co²⁺ or Cu²⁺; M2³⁺ is a trivalent metal ion such as Al³⁺, Fe³⁺, Mn³⁺ or Co³⁺; and Aⁿ⁻ is a counter anion such as a nitrate ion, a carbonate ion, or a chloride ion.

The catalyst may be disposed on or bonded to the electroconductive material with a binder. Suitable binders include polyvinylidene fluoride (PVDF), polytetrafluoroethylene (PTFE), an elastomeric resin such as styrene butadiene rubber (SBR rubber), or the like, or a combination thereof. The content of binder in the air electrode catalyst layer is not particularly limited, and may be, for example, less than 30 wt %, or 1 to 20 wt %, or 2 to 10 wt %, based on a total weight of the air electrode catalyst layer. The catalyst layer may have a thickness of 0.5 to 500 micrometers (μm), or from 1 μm to 200 μm.

When the second electrode is an OER electrode, it may be permeable to the alkaline electrolyte. For example, the second electrode may be formed from a porous metal sheet or mesh. In some embodiments, the second electrode may preferably be formed of a nickel mesh or a nickel-plated steel mesh. The OER electrode may include an oxygen evolution catalyst effective to catalyze oxygen evolution. For example, the OER electrode may include a porous metal mesh and an oxygen evolution catalyst disposed thereon. Exemplary oxygen evolution catalysts include nickel, alloys of nickel with iron, manganese oxide, iron, nickel oxide (NiOₓ), nickel oxyhydroxide (NiOₓ(OH)_{y}), iron oxide (FeOₓ), iron oxyhydroxide (FeOₓ(OH)_{y}), or the like, or a combination thereof.

When the second electrode is an ORR electrode, it is preferably permeable to oxygen. The ORR electrode may include an oxygen reduction catalyst (herein also referred to as a conductive gas diffusion electrode (GDE) catalyst), including carbon, manganese oxide, silver, platinum, nickel foam, a nickel mesh, or the like, or a combination thereof, and may also include a hydrophobic material, such as polytetrafluoroethylene (PTFE). For example, the ORR electrode may include a hydrophilic region and a hydrophobic region. The hydrophobic region may be exposed to air and the hydrophilic region may be exposed to the alkaline electrolyte.

The second electrode may include a gas diffusion material to facilitate transport of oxygen or air to the catalyst, during discharge, or facilitating transport of oxygen generated during charge to the exterior. The gas diffusion material may function as a current collector and support of the ORR or OER catalyst layer on the gas diffusion material to provide a gas diffusion layer. The gas diffusion layer may include carbon, a metal, a conductive ceramic, or the like, or a combination thereof. In some embodiments, the gas diffusion material may be a porous conductive sheet including carbon. The gas diffusion layer may be a woven or non-woven carbon material, such as carbon paper, or a woven or non-woven metal mesh, such as an expanded metal material.

A current collector may be used. The material of the current collector is not particularly limited, provided that the material has suitable conductivity. Examples include stainless steel, nickel, aluminum, iron, titanium, or carbon. The current collector may have any suitable shape, and may be a foil, plate, or mesh. For example, the current collector may be in the form of a metal plate, such as an iron, nickel, stainless steel, nickel-plated stainless steel plate, or the like. Use of an expanded metal mesh is mentioned. The current collector may be a mesh or perforated sheet having void dimensions (e.g., through holes) ranging from 0.1 to 10 millimeters (mm), to facilitate electrolyte flow therethrough. The current collector may be disposed so as to be in contact with the gas diffusion layer or air electrode catalyst layer. The first and second electrodes may each be provided with a separate current collector that collects charge. The thickness of the current collector may be 10 to 1000 μm, or 20 μm to 400 μm. The current collector may be porous or nonporous.

In some embodiments, the first electrode, the alkaline electrolyte, or a combination thereof, further comprises a sulfide-containing compound (e.g., a sulfide). The sulfide-containing compound may comprise iron sulfide, iron disulfide, iron-copper sulfide, zinc sulfide, manganese sulfide, tin sulfide, copper sulfide, cadmium sulfide, silver sulfide, titanium disulfide, lead sulfide, molybdenum sulfide, nickel sulfide, antimony sulfide, lithium sulfide, selenium sulfide, mercury sulfide, polysulfide salts, or a combination thereof, preferably zinc sulfide, sodium sulfide, potassium sulfide, or a combination thereof. The sulfide-containing compound may also include one or more suboxides of a metal sulfide (e.g., FeS₁₋ₓOₓ), or a solid solution of a metal sulfide and an oxide or hydroxide. For example, the sulfide source materials may include minerals such as a sulfosalt mineral, which is a salt of a metal (e.g., Cu, Pb, Ag, Fe, Hg, Zn, or V), a semi-metal (e.g., As, Sb, Bi, or Ge) and sulfur. Example sulfosalts include pyrargyrite (Ag₃SbS₃) and tennantite (Cu₁₂As₄S₁₃). In some cases, e.g., depending on an electrolyte composition or other factors, the sulfide-containing compound may include, non-metal sulfide compound, such as dimethylsulfide, or carbon disulfide.

In some embodiments, the sulfide-containing compound may be in a particulate or a granular form, and may be added to the negative electrode. For example, iron sulfide, e.g., FeS, Fe₃S₄, or Fe₂S₃, may be generated in-situ as a reaction product or intermediary upon charge or discharge. While not wanting to be bound by theory, it is understood that the sulfide-containing compound does not undergo an electrochemical reaction, and thus the sulfide-containing compound is not electrochemically active in the operating potential of the first electrode. Electrochemically active as used herein refers to an ability to undergo oxidation or reduction in the prescribed operational conditions. With respect to the sulfide, the counter-ion to the sulfide may be reduced, and sulfide or hydrosulfide ions may be released. A non-limiting example is M3S+2e⁻→M3⁰+S²⁻. This is distinct from sulfides undergoing electrochemical reactions in solution to form a polysulfide, sulfate, or sulfite, etc., such as in the case of bismuth sulfide. In an aspect, the sulfide or hydrosulfide ion forms a complex with tin or tin-containing species.

The sulfide-containing compound may be contained in the alkaline electrolyte, and a concentration of the sulfide may be 0.001 to 0.5 molar. Use of sodium sulfide is mentioned. In some embodiments, the sulfide may be included as an additional component in the alkaline electrolyte to provide a sulfide concentration of 0.00001 to 0.5 molar. Other salts, such as potassium sulfide, may be used to add sulfide to the alkaline electrolyte. In some embodiments, the alkaline electrolyte may have no sulfide therein. In some embodiments, sulfide may be present in other aspects of the electrochemical cell, and may be included in the first electrode. As an example, sulfide or a sulfide-containing compound may be included in the first electrode when the alkaline electrolyte has no sulfide therein. For example, the alkaline electrolyte may have no detectable sulfide therein, and may have a sulfide concentration of less than 1 nanomolar.

The alkaline electrolyte may further include a hydrogen evolution reaction (HER) suppressant to slow or reduce hydrogen evolution. The HER suppressant may include lead, indium, tin, antimony, copper, silver, bismuth, gold, an oxide thereof, or a combination thereof. In an aspect, the tin species of the HER suppressant may be different from the additive comprising tin. The HER suppressant may be added to the alkaline electrolyte to improve reduction of the iron negative electrode. Alternatively, the HER suppressant may be incorporated into the iron electrode. Additional details are provided in U.S. Patent Publication No. 2022/0367911, the content of which is incorporated herein in its entirety by reference for all purposes.

Other exemplary additional components that may be included in the alkaline electrolyte include zinc oxide, bismuth oxide, antimony oxide, or a combination thereof.

A separator, such as the polypropylene mesh 105, may be included between the first electrode and the second electrode. The separator may be a passive separator, such as porous membrane, or may be an active separator, such as ion exchange membrane. In some embodiments, a separator may be selected to provide selective transfer of desired molecules or materials while substantially limiting or preventing transfer of undesired molecules or materials, such as ion-selective materials that allow the transfer of negative (or positive) ions while substantially preventing transfer of positive (or negative) ions. In other examples, separator materials may be chosen based on an ability to allow or prevent the cross-over of gas bubbles from the positive or the negative electrode, to the opposite side associated with the other of the positive or the negative electrode).

The separator may comprise a dielectric material, which may be porous, and which is permeable to positive ions, such as Fe²⁺, Fe³⁺, K⁺, Na⁺, Cs⁺, or NH₄⁺ ions, or a combination thereof. The separator may be permeable to negative ions, such as hydroxide ions. The separator may be impermeable to active materials of the catholyte or the anolyte. The separator may be a membrane formed from a polymer with a tetrafluoroethylene backbone and side chains of perfluorovinyl ether groups terminated with sulfonate groups, e.g., a sulfonated tetrafluoroethylene membrane, such as NAFION.

The separator may include an anion exchange membrane (AEM), a cation exchange membrane (CEM), a zwitterionic membrane, a porous membrane having an average pore diameter of less than 10 nanometers, a polybenzimidazole-containing membrane, a polysulfone-containing membrane, polycarboxylic-containing membrane, a polyetherketone-containing membrane, a membrane including polymer(s) of intrinsic microporosity (PIM), or the like, or a combination thereof. Preferably, the separator includes an anion exchange membrane (AEM) or a cation exchange membrane (CEM). In some embodiments, the separator may include a composite membrane including an inorganic material and an organic material. In some embodiments, the inorganic material may include a metal oxide or a ceramic material. In some embodiments, the organic material may include a polyether ether ketone (PEEK), a polysulfone, a polystyrene, a polypropylene, a polyethylene, or the like, or a combination thereof.

In some embodiments, the separator may provide a physical barrier between the first electrode and the second electrode. For example, the separator may include a porous polyolefin film, a glass fiber mat, a cotton fabric, a rayon fabric, cellulose acetate, paper, or the like, or a combination thereof. In some embodiments, the separator may be a dielectric structure or frame, a ribbed structure, or a porous insulator. In some embodiments, the separator may include a porous frame configured to compress the iron electrode.

### Battery and Device

An aspect provides a battery comprising the electrochemical cell comprising the additive comprising M, Fe₃₋ₓMₓO₄, or a combination thereof. The battery may comprise a plurality of the electrochemical cells, and the cells may be connected in any suitable combination of series and parallel connections. Also provided is a method of manufacturing the battery, where the method includes providing a plurality of the electrochemical cells, and connecting the electrochemical cells in series, parallel, or a combination thereof, to manufacture the battery.

An aspect provides a device including the battery. An aspect provides a system including the battery. Also, an aspect provides a power grid comprising the battery. In an aspect, the battery is connected to a power source, such as a solar panel or a wind turbine, is configured to be charged by the power source, and can be discharged to provide power to the power grid.

### Methods

An aspect provides a method of operating the electrochemical cell. The method comprises providing an electrochemical cell according to the present disclosure, discharging the electrochemical cell at a C rate of less than C/12, preferably C/150 to C/12, to oxidize the iron to Fe₃₋ₓMₓO₄ wherein 0≤x<1; and charging the electrochemical cell to operate the electrochemical cell.

A C rate as used herein is obtained by dividing a discharge capacity of the electrochemical cell on a first cycle by a discharge time in hours. For example, a C rate of C/12 corresponds to a rate that will discharge the cell in 12 hours, based on the capacity on the first discharge.

The discharging the electrochemical cell at a C rate may be less than C/12, for example C/150 to C/12, C/90 to C/18, C/60 to C/24, or C/36 to C/30.

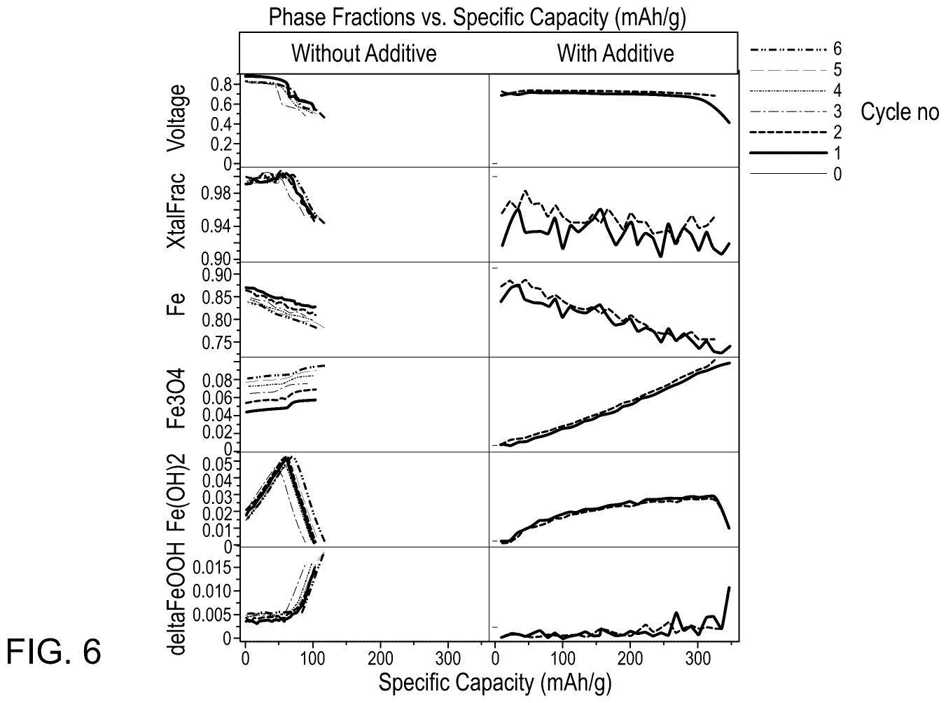

In an aspect, when discharging the electrochemical cell at a C rate of less than C/12, preferably C/150 to C/12, the additive is effective to concurrently oxidize the iron to iron (II) hydroxide and the iron (II) hydroxide to Fe₃₋ₓMₓO₄. “Concurrently oxidize the iron,” as used herein, means conversion of iron (II) hydroxide to Fe₃₋ₓMₓO₄ (e.g., magnetite) occurs at rate such that the iron (II) hydroxide is not detected; or the content of the iron (II) hydroxide appears unchanged. X-ray diffraction analysis demonstrates that the discharge process is exclusive of detection of other iron oxide products, e.g., δ-Fe(OOH) is not detected during discharge, which is further discussed in the Example section regarding FIG. 6.

In an aspect, when discharging the electrochemical cell at the C rate of less than C/12, a density of the iron in the first electrode is less than 2.11 g/cm³, based on a total weight of the iron and a total volume of the first electrode, and the first electrode has a specific discharge capacity (Q) on a first discharge plateau greater than 960 mAh/gram of iron, based on the total weight of the iron in the first electrode.

In an aspect, the density of the iron in the first electrode is 1.85 to 2.11 g/cm³, 1.9 to 2.05 g/cm³, or 1.95 to 2 g/cm³, each based on the total weight of the iron and the total volume of the first electrode, and the first electrode has a specific discharge capacity on the first discharge plateau of 960 to 1280 mAh/g_{Fe}, 1000 to 1200 mAh/g_{Fe}, or 1050 to 1150 mAh/g_{Fe}, each based on the total weight of the iron in the first electrode.

In an aspect, the electrochemical cell is an iron-air cell, and the discharging is at a C rate of C/150 to C/36, C/120 to C/48, or C/90 to C/60.

In an aspect, the electrochemical cell is an iron-manganese oxide cell, and the discharging is at a C rate of C/150 to C/12, C/120 to C/48, or C/90 to C/60.

In an aspect, the specific discharge capacity of the first electrode is 100% to 329%, 110% to 300%, 120% to 250%, or 133% to 200% of a theoretical specific discharge capacity of the first electrode determined based on an assumption that 100% of the pores in the first electrode are filled with Fe(OH)₂.

In an aspect, the oxidation of the iron of the first electrode comprises forming magnetite, incorporating M into magnetite, forming the Fe₃₋ₓMₓO₄, or a combination thereof; and the charging comprises reducing the magnetite, the Fe₃₋ₓMₓO₄, or a combination thereof, to iron metal.

In an aspect, the charging of the electrochemical cell to reduce the magnetite, the Fe₃₋ₓMₓO₄, or a combination thereof, to the iron metal comprises converting 95 to 100 wt %, 96 to 99.5 wt %, or 97 to 99 wt %, preferably 98 to 100 wt %, of the magnetite, the Fe₃₋ₓMₓO₄, or a combination thereof, to the iron metal, based on a total weight of the magnetite, the Fe₃₋ₓMₓO₄, or a combination thereof.

The method of operating the electrochemical cell may include heating the electrochemical cell to an operation temperature, wherein the operation temperature is 0° C. to 75° C., 25° C. to 55° C., or 25° C. to 45° C.; and discharging the electrochemical cell to form the Fe₃₋ₓMₓO₄. The temperature of the electrochemical cell may be selected by use of insulation around the cell and/or a heater.

### Tin-Iron Compound

In another aspect, an electrochemical method to produce a tin-iron compound comprises: providing an electrochemical cell comprising a first electrode comprising iron, an alkaline electrolyte, a second electrode, and an additive comprising tin; and discharging the electrochemical cell to oxidize the iron of the first electrode and produce the tin-iron compound, wherein the tin-iron compound comprises tin, iron, and oxygen.

The tin-iron compound may have a formula of Fe₃₋ₓSnₓO₄, wherein 0<x≤1, 0.05≤x≤0.9, or 0.1≤x≤0.8. The tin-iron compound may have a formula of Fe₃₋ₓSnₓO₄, wherein 0<x<1. The tin-iron compound may have a formula of Fe₃₋ₓSnₓO_{4-δ}, wherein 0<x≤1, 0.05≤x≤0.9, or 0.1≤x≤0.8 and 0≤δ≤1, 0.001≤δ≤0.1, or 0.005≤δ≤0.05. In an aspect, δ may represent a content of oxygen defects. In a specific aspect, the tin-iron compound may be tin-doped magnetite.

The tin-iron compound may be isostructural with magnetite. In an aspect, the tin-iron compound is a tin-doped magnetite of the formula Fe₃₋ₓSnₓO₄, wherein 0<x≤1, or of the formula of Fe₃₋ₓSnₓO_{4-δ}, wherein 0.01<x≤1, and 0≤δ≤1. Oxygen defects may be introduced into the magnetite crystal structure when iron is oxidized in the presence of an electrolyte comprising tin. Additionally or alternatively, tin may be introduced into the magnetite crystal structure when iron is oxidized in the presence of an electrolyte comprising tin.

In an aspect, the tin-iron compound has a cubic unit cell having a lattice parameter of greater than 8.399 Angstroms (Å) at room temperature, e.g., 20° C., for example, from 8.399 to 8.610 Å, 8.405 to 8.605 Å, or 8.407 to 8.600 Å, preferably from 8.410 to 8.595 Å. A lattice parameter of a crystal structure of magnetite at room temperature is a=b=c=8.396 Å, wherein a, b, and c, are each length of the edges in the x, y, and z directions, respectively, of a cubic unit cell of the magnetite crystal structure. The tin-iron compound has a lattice parameter greater than the lattice parameter of the magnetite when determined under the same conditions including e.g., temperature, or pressure. In an aspect, in the tin-iron compound, at least one of a, b, or c is greater than 8.396 Å. In an aspect, each of a, b, or c is greater than 8.396 Å. The lattice parameter may be determined by the method of indexing. In this method the reflections from the diffraction pattern that correspond to magnetite, which may be identified by comparison to standard patterns, are indexed to their corresponding h,k,l lattice planes. Reflections due to other components, such as metallic iron, should be excluded. The lattice parameter is determined by the equation (l/d²)=(h²+k²+l²)/a² where d is the spacing of the lattice plane determine by the position of the reflection via Bragg's law, h, k, and l are the indexes of the lattice plane, and a is the dimension of the cubic unit cell. The a parameter is determined for each reflection, the value and 95% confidence interval may be determined by usual statistical methods. Alternatively, the magnetite unit cell parameter may be determined by the method of Rietveld refinement using commercial or open-source tools. This method has the advantage of allowing for compensation for the impact of x-ray source and instrument geometry effects as well as the impacts of finite crystallite size and overlapping peaks from additional components of the electrode.

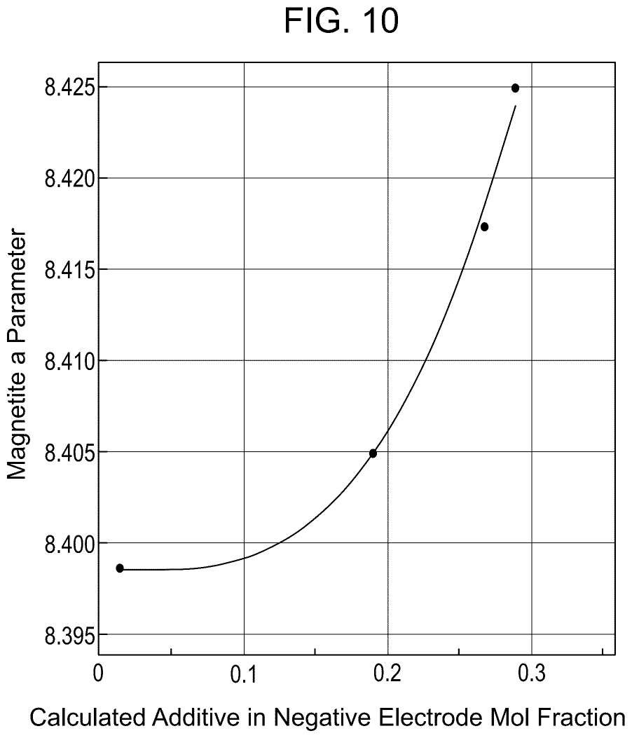

FIG. 10 is a graph of magnetite lattice parameter (a) vs a calculated mole fraction of tin in the negative electrode, and shows magnetite lattice parameter expansion upon tin incorporation. Four different samples were used from four different cells. The tin amount was determined by an inductively coupled plasma (ICP) analysis of the electrode materials after sample harvesting.

While not wishing to be bound by theory, it is understood that the lattice parameter of tin-iron compound increases as the tin, which is larger than the iron, is incorporated into the magnetite crystal structure. Cubic symmetry is understood to be maintained. In an aspect, at least part of an iron site in the magnetite crystal structure may be occupied by the tin, during the tin incorporation, resulting in tin substitution for iron.

In an aspect, the first (i.e., negative) electrode comprises a compound having a peak centered at 17.420 to 18.254 °2θ, for example, 17.500 to 18.200 °2θ, or 17.600 to 18.100 °2θ, when analyzed by X-ray diffraction using Cu Kα radiation. In an aspect, the alkaline electrolyte may also further comprise the compound having a peak centered at 17.420 to 18.254 °2θ, for example, 17.500 to 18.200 °2θ, or 17.600 to 18.100 °2θ, when analyzed by X-ray diffraction using Cu Kα radiation. The alkaline electrolyte may comprise the tin-iron compound, which may be electrodeposited from the electrolyte with iron. The tin-iron compound has a peak centered at 17.420 to 18.254 °2θ, for example, 17.500 to 18.200 °2θ, or 17.600 to 18.100 °2θ, when analyzed by X-ray diffraction using Cu Kα radiation. In an aspect, the tin-iron compound has a peak centered at 17.420 to 18.254 θ2θ, for example, 17.500 to 18.200 °2θ, or 17.600 to 18.100 °2θ, when analyzed by X-ray diffraction using Cu Kα radiation.

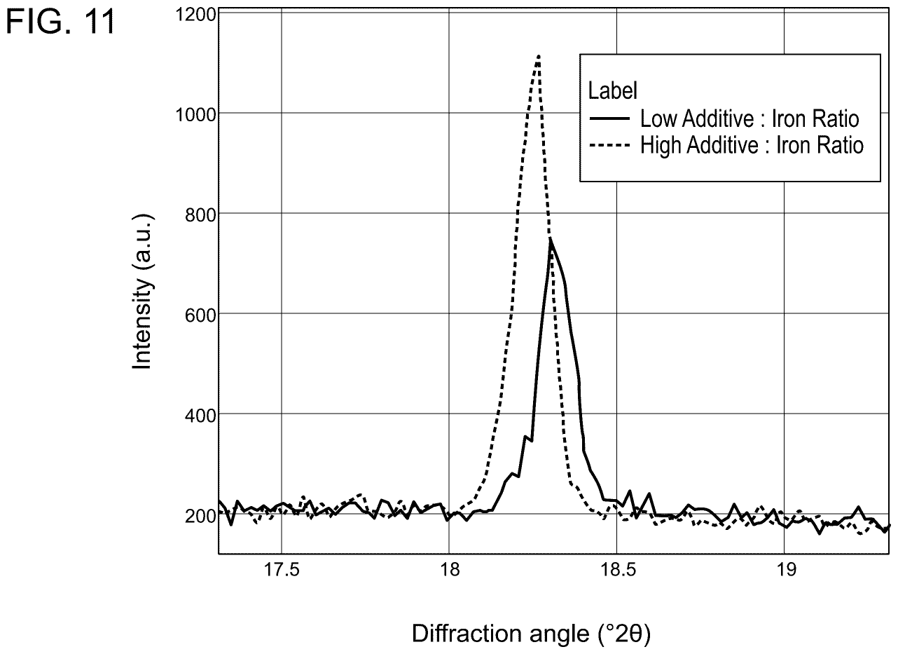

FIG. 11 shows the results of X-ray diffraction spectroscopy of a discharged iron negative electrode showing shifting of a peak centered at 17.420 to 18.254 °2θ depending on a tin to iron ratio (concentration of tin per mass of iron). The low additive sample has 64 micromoles of tin per gram iron. The high additive sample has 3,200 micromoles of tin per gram of iron. Data was collected on a Bruker Advance diffractometer with a Cu X-ray source.

In an aspect, the tin-iron compound is in a form of a particle having an average particle size of less than 100 micrometers (μm), for example, 1 nanometer (nm) to 50 μm, 10 nm to 30 μm, or 100 nm to 10 μm. The particle may have any suitable shape, and may have a spherical, platelet, or needle-like shape. A particle size herein may be a length of the longest axis of a particle. The average particle size may be calculated by analyzing the sizes of the particles by scanning electron microscopy. An average particle size may be a mean, a median, or preferably a volume-average D50.

In an aspect, the first electrode further comprises the tin-iron compound. The tin-iron compound may be disposed within the first electrode, or the tin-iron compound may be disposed on a surface of the first electrode. When present, a content of the tin-iron compound in the first electrode may be 0.5 to 25 wt %, 1 to 20 wt %, 5 to 20 wt %, or 10 to 15 wt %, based on a total weight of the first electrode.

The additive comprising tin may be included as tin metal, as a tin-containing compound, or a combination thereof. Exemplary tin species include tin metal (i.e., metallic tin), sodium stannate, sodium stannate trihydrate (Na₂SnO₃·3H₂O), potassium stannate, potassium stannate trihydrate (K₂SnO₃·3H₂O), calcium stannate (CaSnO₃), magnesium stannate (MgSnO₃), barium stannate (BaSnO₃), cobalt stannate (Co₂SnO₄), tin oxide such as tin (II) oxide (SnO), or tin (IV) oxide (SnO₂), cylindrite (Pb₃Sn₄FeSb₂S₁₄), canfieldite (Ag₈SnS₆), copper iron tin sulfide (Cu₂FeSnS₄), a lead-tin alloy (such as 60/40 Sn/Pb solder, or 63/37 Sn/Pb solder, a Terne I alloy comprising 10-20% Sn, balance Pb), a zinc-tin alloy (such as a Terne II alloy comprising 10 to 20% Sn, balance Zn), iron tin oxide, tin chloride (SnCl₂), tin sulfide (SnS or SnS₂), tin sulfate (SnSO₄), or a combination thereof. In an aspect, the additive comprising tin preferably comprises sodium stannate, potassium stannate, or a combination thereof.

In an aspect, the additive comprising tin comprises tin having an oxidation state of 0. +2, +4, or a combination thereof. While not wishing to be bound by theory, it is understood that tin having an oxidation state of +2, such as tin (II) oxide, tin having an oxidation state of +4, such as tin (IV) oxide, tin having an oxidation state of 0, such as metallic tin, or a combination thereof, may contribute to the formation of the tin-iron compound.

In an aspect, the additive comprising tin is contained in the first electrode, the alkaline electrolyte, or a combination thereof.

When the first electrode comprises the additive comprising tin, and an amount of the additive in the first electrode may be 0.1 to 40 wt %, 1 to 30 wt %, or 10 to 20 wt %, based on a total weight of the first electrode.

When the alkaline electrolyte comprises the additive comprising tin, an amount of tin or tin-containing compound in the alkaline electrolyte may be greater than 0.1 mM, for example 0.1 to 200 mM, 10 to 150 mM, or 30 to 90 mM, based on a total volume of the alkaline electrolyte.

In an aspect, the alkaline electrolyte comprises the additive comprising tin, and an amount of tin or tin-containing compound in the alkaline electrolyte may be at or near a solubility limit of tin-containing species in the alkaline electrolyte. A source of additional tin may be placed in contact with the electrolyte such that upon formation of the tin-iron compound, more tin may be available to dissolve into the alkaline electrolyte. In this way, tin may be functionally available in the electrolyte at levels exceeding the solubility limit of tin in the electrolyte.

The alkaline electrolyte may be an aqueous solution, an ionic liquid, a gel, or a solid. Further details of the alkaline electrolyte are described elsewhere herein.

The first electrode may be a negative electrode of the electrochemical cell and may be an anode on discharge. The first electrode, which may be referred to herein as the “iron electrode,” may be a solid, and may be in a form of a non-porous or porous solid, a mesh, or foam, and may be comprised of collection of particles. Use of an iron monolith is mentioned. As another example, the iron electrode may be a collection of particles in a suspension such that the particles are not buoyant enough to escape the suspension into the electrolyte. When the electrochemical cell is discharged, the iron of the first electrode is oxidized to produce the tin-iron compound comprising tin, iron, and oxygen. In an aspect, the oxidizing of the iron of the first electrode comprises forming magnetite, incorporating tin into the magnetite, forming the tin-iron compound, or a combination thereof.

The electrochemical cell may have a configuration as illustrated in FIG. 3 as described herein. In an aspect, the tin-iron compound may be incorporated into the electrochemical cell before applying a voltage to the electrochemical cell.

The electrochemical cell may be heated to an operation temperature, wherein the operation temperature is 0° C. to 75° C., 25° C. to 55° C., or 25° C. to 45° C.

The disclosed tin-iron compound, when incorporated in an electrochemical cell may provide improved performance, and may facilitate oxidation and reduction of iron or an iron containing compound. For example, the electrochemical cell, e.g., an iron-air cell, may have one or more of an improved coulombic efficiency, an improved energy efficiency, an improved voltaic efficiency, an improved specific discharge capacity, a reduced hydrogen evolution, or a combination thereof, relative to a same iron-air cell without the tin-iron compound.

A negative electrode for an alkaline electrochemical cell represents another aspect of the disclosure, the negative electrode comprising: a current collector; and a negative electrode active material layer comprising a negative electrode active material on the current collector, wherein the negative electrode active material comprises the tin-iron compound described herein. The negative electrode active material may optionally comprise additional iron-containing compounds that do not comprise tin.

The tin-iron compound may be incorporated in the negative electrode active material when assembling the negative electrode. The tin-iron compound may be from a source not obtained from discharging an electrochemical cell. Alternatively, the tin-iron compound may be formed by discharging an electrochemical cell to oxidize the iron of the negative electrode.

In the negative electrode, a ratio of the tin-iron compound to iron in the negative electrode active material layer may be greater on a surface of the negative electrode active material layer opposite the current collector than on a surface of the negative electrode active material layer adjacent the current collector. In aspect, the negative electrode comprises a gradient such that the surface of the negative electrode adjacent the current collector comprises 10 to 99 wt % iron, 20 to 95 wt % iron, or 30 to 90 wt % iron, and the surface of the negative electrode opposite the current collector comprises 10 to 99 wt % of the tin-iron compound, 20 to 95 wt % of the tin-iron compound, or 30 to 90 wt % of the tin-iron compound, based on a total weight of the portion of the negative electrode analyzed. Analysis by SEM-EDS is mentioned.

In the negative electrode, the tin-iron compound, for example the tin-doped magnetite, may have a tin content of 1 to 25 wt %, 5 to 20 wt %, or 10 to 15 wt %, based on a total weight of the negative electrode; or a tin content of 1 to 25 wt %, 5 to 20 wt %, or 10 to 15 wt %, based on a total weight of the tin-doped magnetite.

An aspect provides an electrochemical cell comprising the negative electrode; an alkaline electrolyte; and a positive electrode. The positive electrode may be any suitable electrode used as a positive electrode in the field.

An aspect provides a method of operating the electrochemical cell described herein, the method comprising: providing the electrochemical cell comprising a first electrode comprising iron, an alkaline electrolyte, a second electrode, and an additive comprising tin; discharging the electrochemical cell to oxidize the iron of the first electrode and produce the tin-iron compound described herein; and charging the electrochemical cell to convert at least a portion of the tin-iron compound to iron metal. The method may further comprise a second discharge cycle of discharging the electrochemical cell to oxidize iron and produce the tin-iron compound.

In an aspect, the oxidizing the iron of the first electrode comprises forming magnetite, incorporating tin into magnetite, forming the tin-iron compound, or a combination thereof; and the charging comprises reducing the magnetite, the tin-iron compound, or a combination thereof, to iron metal.

In an aspect, the charging of the electrochemical cell to reduce the magnetite, the tin-iron compound, or a combination thereof, to the iron metal comprises converting 95 to 100 wt %, 96 to 99.5 wt %, or 97 to 99 wt %, preferably 98 to 100 wt %, of the magnetite to the iron metal, based on a total weight of the magnetite, or converting 95 to 100 wt %, 96 to 99.5 wt %, or 97 to 99 wt %, preferably 98 to 100 wt %, of the tin-iron compound to iron metal, based on a total weight of the tin-iron compound.

The method of operating the electrochemical cell may include heating the electrochemical cell to an operation temperature, wherein the operation temperature is 0° C. to 75° C., 25° C. to 55° C., or 25° C. to 45° C.; and discharging the electrochemical cell to form the tin-iron compound.

An aspect provides a battery comprising the electrochemical cell comprising the tin-iron compound. The battery may comprise a plurality of the electrochemical cells, and the cells may be connected in any suitable combination of series and parallel connections. Also provided is a method of manufacturing the battery, where the method includes providing a plurality of the electrochemical cells, and connecting the electrochemical cells in series, parallel, or a combination thereof, to manufacture the battery.

An aspect provides a device including the battery. An aspect provides a system including the battery. Also, an aspect provides a power grid comprising the battery. In an aspect, the battery is connected to a power source, such as a solar panel or a wind turbine, is configured to be charged by the power source, and can be discharged to provide power to the power grid.

### EXAMPLES

### Example 1—Porous Iron Electrodes with Iron Sulfide

Iron electrodes (26.67 cm²) were fabricated from high purity sponge iron with a particle size range from 75 to 850 micrometers. Each iron electrode comprised nominally 16 grams of iron powder. Iron sulfide was added in the range of 3 to 6 weight percent and evenly dispersed by powder mixing. The electrode powder was placed in a die and pressed at 850-925° C. for 1-5 minutes.

A nickel-plated steel mesh electrode was used as the charge counter electrode. A carbon-based (i.e., carbon-containing) gas diffusion electrode was used as a discharge counter electrode. Humidified air was provided to the gas electrode. The electrolyte comprised 6.5 molar (M) potassium hydroxide with 60 millimolar (mM) sodium stannate and 1,500 to 30,000 milligrams per liter (mg/L) zinc oxide in water. The water was provided by a reverse osmosis system. Cells were charged with 500 milliliter (mL) of the electrolyte. A nickel wire was inserted between the counter electrodes and the iron electrode as a pseudo reference electrode.

The cells were assembled in a high density polyethylene container with a gasket seal. Wires and tubing for air delivery and removal were placed through the lid and sealed with gaskets and other sealing methods to prevent un-intended air leakage. The cell was fitted with a pressure relief device to prevent over pressurization of gaseous products. The cells were placed in an isothermal incubator held at 15 to 50° C. and connected to a galvanostatic cycler and cycled at constant current. Current densities ranged from 13-26 mA/cm² on discharge and 18 to 42 mA/cm² on charge. Discharge was terminated at a cell voltage of 0.4 V and charge was terminated at a fixed capacity, which ranged from 400 to 1500 mAh/g. Some cycles included intermediate steps to estimate the cell DC resistance.

### Example 2—Atomized Iron Source

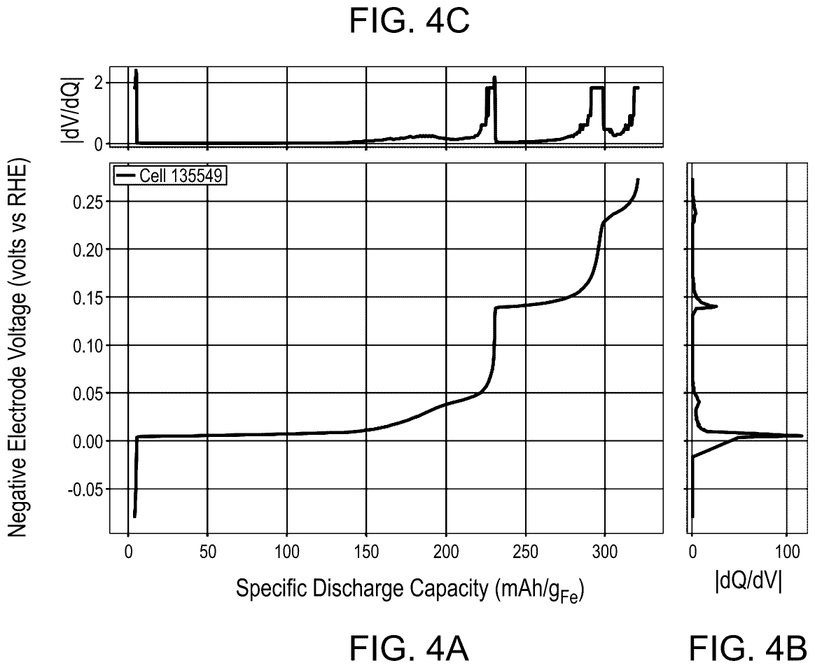

Iron electrodes (26.67 cm²) were fabricated from atomized iron and atomized iron and sponge iron blends with 5% zinc sulfide. Each iron electrode comprised nominally 78 grams of iron powder and had a density of 3.8 to 4.1 g/cm³. Electrochemical cycling occurred at 45° C. with a 10 mA/g charge rate and 8.67 mA/g discharge rate. Cells were assembled in plastic containers with nickel/steel mesh and gas diffusion counter electrodes for charge and discharge respectively. Some cells were assembled without a gas diffusion electrode to study the iron electrode performance in the absence of the gas diffusion electrode. For example, some cells were assembled with a nickel pseudo-reference electrode or a mercury-mercuric oxide reference electrode. Electrolyte comprising 6.5 M potassium hydroxide and 60 mM sodium stannate was added to the assembled cell such that the electrodes were fully submerged. FIG. 4A shows a discharge curve from a cell from Example 2. FIG. 4B shows a graph of negative electrode voltage (volts vs. RHE) versus differential capacity (dQ/dV) for Example 2. FIG. 4C shows a graph of differential voltage (dV/dQ) versus specific discharge capacity (mAh/g_{Fe}) for Example 2. The primary discharge plateau of iron occurs between 0 and +0.02 V vs RHE as can be observed by a maximum in the |dQ/dV| and a near 0 value of |dV/dQ|.

### Example 3—Magnetite and Hematite Iron Source

Iron electrodes (26.67 cm²) were fabricated from magnetite, magnetite and iron, and hematite and iron blends. Each iron electrode comprised nominally 16 grams equivalent of metallic iron and had a density of 2.9 to 3.3 g/cm³. After pressing (as described in Example 1), the iron and iron oxide blends contained a mix of phases including iron, magnetite and wustite which convert to iron upon charging as confirmed by x-ray diffraction spectroscopy. Cells were assembled in plastic containers with nickel/steel mesh and gas diffusion counter electrodes for charge and discharge respectively. Some cells were assembled without a gas diffusion electrode to study the iron electrode performance in the absence of the gas diffusion electrode. For example, some cells were assembled with a nickel pseudo-reference electrode or a mercury-mercuric oxide reference electrode. Electrolyte comprising 6.5 M potassium hydroxide, 60 mM sodium stannate, and 1 to 5 mM Na₂S was added to the completed cells such that the electrodes were fully submerged.

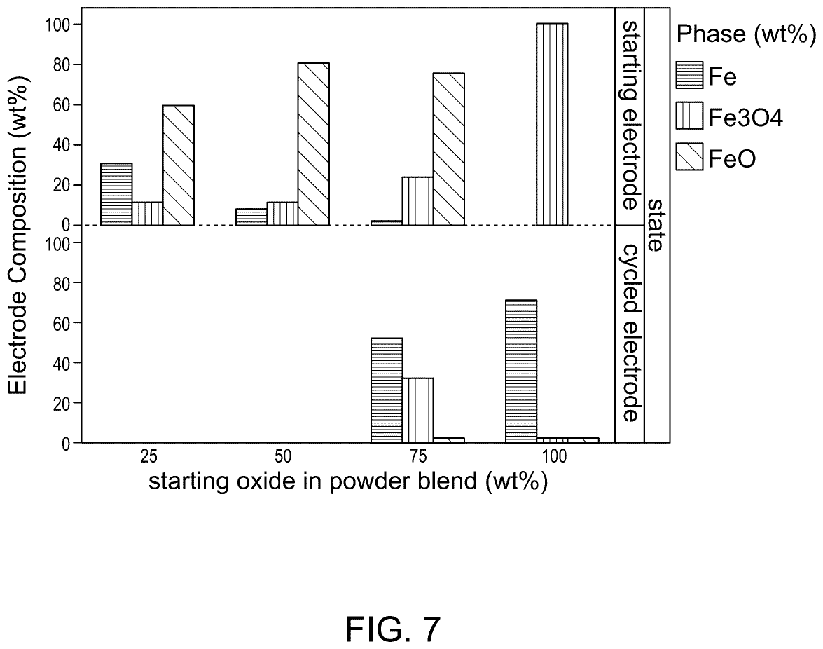

FIG. 7 provides the iron phase composition of the electrodes of Example 3 before cycling (neat negative electrode). The phase composition for starting oxide powder blends of 75% and 100% are also illustrated after cycling (cycled negative electrode) in FIG. 7. After cycling, wustite (FeO) was found to convert to Fe metal or Fe₃O₄, consistent with effective reduction of other oxides to Fe. Electrodes were cycled by charging to a fixed charge capacity varying from 300 to 1200 mAh/g, and discharging to a cell voltage limit of 0.4 V. Current densities were as described in Example 1.

### Example 4—HPSI/DRI Based Electrodes with ZnS and Sn

Iron electrodes (26.67 cm²) were fabricated from high purity sponge iron (HPSI) or direct reduced iron (DRI), each with a particle size range from 75 to 850 micrometers. Each iron electrode comprised nominally 16 to 88 grams of iron powder. Zinc sulfide was added in the range of 3 to 6 weight percent and evenly dispersed by powder mixing. The electrode powder was placed in a die and pressed at 850-925° C. for 1-5 minutes.

A nickel-plated steel mesh electrode was used as the charge counter electrode. A carbon-based gas diffusion electrode was used as a discharge counter electrode. Humidified air was provided to the gas electrode. The electrolyte contained 4 to 8 M potassium hydroxide with 20 to 120 mM sodium stannate. The water was provided by a reverse osmosis system. Cells were charged with 500 milliliter (mL) of the electrolyte such that the electrode assembly was fully immersed in electrode. A nickel wire was inserted between the counter electrodes and the iron electrode as a pseudo reference electrode. In some instances a mercury/mercuric oxide reference electrode was used in place of the nickel wire.

The cells were assembled in a high density polyethylene container with a gasket seal. Wires and tubing for air delivery and removal were placed through the lid and sealed with gaskets and other sealing methods to prevent un-intended air leakage. The cell was fitted with a pressure relief device to prevent over pressurization of gaseous products. The cells were placed in an isothermal incubator held at 15 to 60° C. and connected to a galvanostatic cycler and cycled at constant current. Current densities ranged from 10 to 30 mA/cm² on discharge and 10 to 42 mA/cm² on charge. Discharge was terminated at a cell voltage of 0.4 V and charge was terminated at a fixed capacity, which ranged from 400 to 1500 mAh/g. Some cycles included intermediate steps to estimate the cell DC resistance.

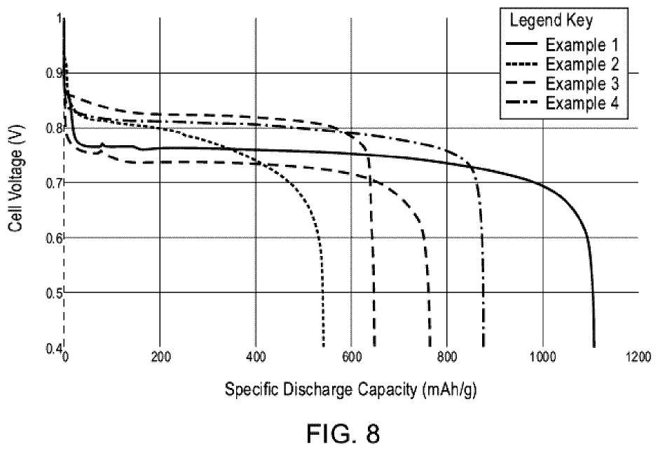

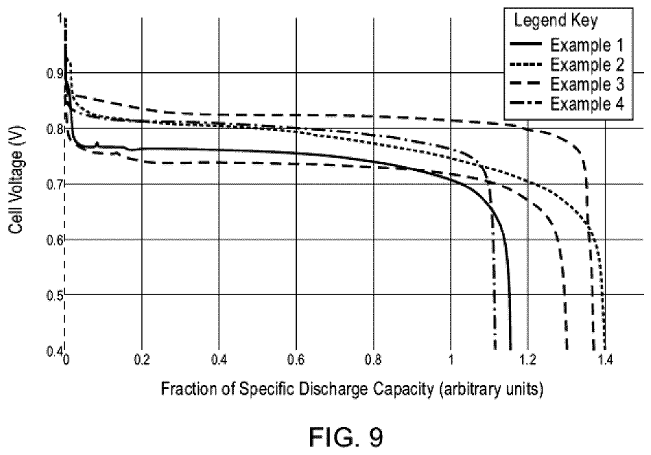

FIGS. 8 to 9 illustrate exemplary discharge curves for cells from Examples 1 to 4. Details for the specific electrodes are provided in Table 4. The electrode pressing conditions, cycling conditions, and cell configurations were the same as those used in Examples 1 through 4 respectively. Curves labeled as Example 3 are independent observations at the same experimental condition. These discharge profiles show single voltage plateaus at cell voltages above 0.7 V which exceed the theoretical capacity of Fe(OH)₂.

TABLE 4
Test Electrodes

| | Iron | | | |
|---|---|---|---|---|
| | Density | Iron | Electrode | |
| Example | (g_{Fe}/cm³) | Source | Additives | Electrolyte Composition |
| 1 | 1.945 | Sponge | 4.5 wt % | 6.5M KOH, 60 mM Sodium |
| | | Iron | FeS | Stannate, 1,500 mg/L ZnO |
| 2 | 3.745 | Atomized | 5 wt % | 6.5M KOH, 60 mM sodium |
| | | Iron | ZnS | Stannate |
| 3 | 2.637 | Magnetite | | 6.5M KOH, 60 mM sodium |
| | | | | Stannate, 3 mM sodium |
| | | | | sulfide |
| 4 | 2.022 | Sponge | 5 wt % | 5.95M KOH + 0.05M LiOH + |
| | | Iron | ZnS | 40 mM Sodium Stannate |

As shown in FIG. 8, each discharge curve provided a single discharge plateau. The absolute value of the cell voltage varied which was attributed to the performance of the counter electrode and the cell resistance. In all cases the voltage of the first plateau was primarily greater than 0.7 volts and greater than 0.65 volts. Although the discharge capacity for several cycles fell below 960 mAh/g, in all cases the discharge capacity was greater than the theoretical capacity limit for an Fe to Fe(OH)₂ conversion electrode.

### Example 5—with or without Additive

An iron electrode comprising nominally 16 grams of sponge iron with 5 wt % ZnS, was discharged at 25 mA/g and charged at 60 mA/g against a nickel mesh counter electrode. An electrolyte comprising 6M KOH was used for ‘without additive’ condition, and an electrolyte comprising 6M KOH and 80 mM sodium stannate was used for ‘with additive’ condition.

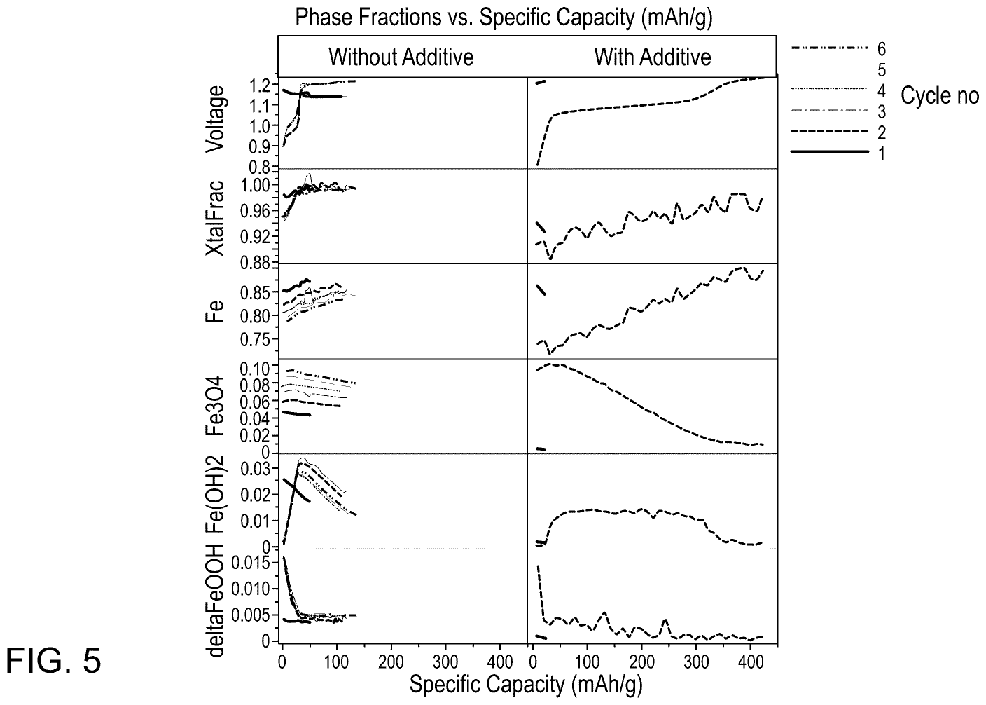

FIGS. 5 and 6 show the results of in-situ operational synchrotron X-ray diffraction analysis demonstrating the effect of the additive on iron oxide consumption during electrode charge, and iron oxide production during electrode discharge, respectively. During charge as shown in FIG. 5, without the additive, reduction of iron oxide products to iron is incomplete and the Fe₃O₄ accumulates over multiple cycles. With the additive, surprisingly reversibility is improved and accumulation of Fe₃O₄ is reduced or avoided. During discharge as shown in FIG. 6, without the additive, Fe(OH)₂ is produced at the start of discharge on the high voltage plateau at a cell voltage of 0.8 V, Fe₃O₄ is produced during the entire discharge and accumulates with additional cycles, and delta-Fe(OOH) (feroxyhyte) is produced on the lower discharge plateau. With the additive, only a single voltage plateau is observed, Fe(OH)₂ is produced and plateaus, and the content of Fe₃O₄ increases monotonically such that with additional cycles, the same product ratios are produced.

### Example 6—Tin-Iron Compound Synthesis

An electrochemical cell comprising a first electrode comprising iron as a working electrode, an alkaline electrolyte comprising 6 M KOH, 0.1 M potassium stannate, and a second electrode was provided. A conductive element was placed between the first electrode and the second electrode and external to the electrochemical cell. Electrical current was passed between the first electrode and the second electrode to form a tin-doped magnetite.

The first electrode was removed from the electrochemical cell, rinsed with water, and analyzed by X-ray diffraction using Cu Kα radiation. A peak was observed at between 17.420 and 18.254 °2θ.

### PROPHETIC EXAMPLES

### Example 7—Magnetite Formation without Tin

An electrochemical cell comprising a first electrode comprising iron as a working electrode, an alkaline electrolyte comprising 6 M KOH, and a second electrode will be provided. A conductive element will be placed between the first electrode and the second electrode and electrical current will be passed between the first electrode and the second electrode to form magnetite without tin. In the event that iron oxyhydroxides were formed, multiple charge/discharge cycles are applied such that magnetite forms.

### Example 8

An electrochemical cell comprising a first electrode comprising iron as a working electrode, an alkaline electrolyte comprising 6 M KOH, and 0.01 M potassium stannate, and a second electrode will be provided. A conductive element will be placed between the first electrode and the second electrode and electrical current will be passed between the first electrode and the second electrode to form tin-doped magnetite. The tin-doped magnetite in this cell has less tin than the first example.

### Example 9

An electrochemical cell comprising a first electrode comprising iron as a working electrode, an alkaline electrolyte comprising 6 M KOH, and 0.1 M tin(II) oxide, and a second electrode will be provided. A conductive element will be placed between the first electrode and the second electrode and electrical current will be passed to form tin-doped magnetite.

### Example 10

An electrochemical cell comprising a first electrode comprising iron as a working electrode, an alkaline electrolyte comprising 6 M KOH, and 0.01 M tin(IV) oxide, and a second electrode will be provided. A conductive element will be placed between the first electrode and the second electrode and electrical current will be passed between the first electrode and the second electrode to form tin-doped magnetite.

### Example 11

Iron powder and tin powder will be combined, pressed to form a monolith, and sintered to form an electrode. The electrode will be contacted with an alkaline electrolyte comprising 4M to 10M KOH and discharged against a nickel counter electrode to form tin-doped magnetite. The presence of tin-doped magnetite will be confirmed by X-ray diffraction analysis of the electrode.

### Example 12

Iron powder and tin powder will be combined, pressed to form a monolith, and sintered to form an electrode. The electrode will be contacted with an alkaline electrolyte comprising 4M to 10M KOH. The electrode will be discharged, and then charged and discharged three times against a nickel counter electrode to form the tin-doped magnetite. While not wanting to be bound by theory, it is understood that the tin will be oxidized on the first discharge cycle, then will dissolve into the electrolyte, and then will incorporate into the iron oxide to form the tin-doped magnetite. The presence of tin-doped magnetite will be confirmed by X-ray diffraction analysis of the electrode.

### Example 13

Iron powder will be pressed to form a monolith, and then sprayed with tin metal to form a tin coating on the monolith. The tin-coated monolith will be sintered to form an electrode. The electrode will be contacted with an alkaline electrolyte comprising 4M to 10M KOH and discharged against a nickel counter electrode to form tin-doped magnetite. The presence of tin-doped magnetite will be confirmed by X-ray diffraction analysis of the electrode.

### Example 14

Iron powder will be pressed to form a monolith. A tin foil will be placed over the monolith on a surface of the iron monolith and will be melted or sintered to the surface, with a thickness chosen such that the tin mass is 2 to 7% of the total iron mass. The electrode will be contacted with an alkaline electrolyte comprising 4M to 10 M KOH and discharged against an oxygen gas diffusion electrode counter to form tin-doped magnetite. The presence of tin-doped magnetite will be confirmed by X-ray diffraction analysis of the electrode.

The subject matter further encompasses the following aspects.

Aspect 1. An electrochemical cell including: a first electrode including iron, wherein a density (D) of the iron in the first electrode is greater than 2.11 g/cm³ and less than 7.87 g/cm³, based on a total weight of the iron and a total volume of the first electrode; an alkaline electrolyte; a second electrode; and an additive including a metal M, wherein the additive is effective to facilitate oxidation of the iron to Fe₃₋ₓMₓO₄, wherein 0≤x<1, optionally 0<x<1, and wherein a specific discharge capacity (Q) of the first electrode in the first discharge plateau is represented by Formula 1 Q>((7.87/D)−1)*352 mAh/gram of iron, based on the total weight of iron in the first electrode (1).

Aspect 2. An electrochemical cell including: a first electrode including iron, wherein a density (D) of the iron in the first electrode is greater than 2.11 g/cm³ and less than 7.87 g/cm³, based on a total weight of iron and a total volume of the first electrode; wherein the first electrode includes Fe₃₋ₓMₓO₄, wherein M is a metal and 0≤x<1, optionally 0<x<1; an alkaline electrolyte; a second electrode; and wherein a specific discharge capacity (Q) of the first electrode in the first discharge plateau is represented by Formula 1 Q>((7.87/D)−1)*352 mAh/gram of iron, based on the total weight of iron in the first electrode (1).

Aspect 3. An electrochemical cell including: a first electrode including iron, wherein a density of the iron in the first electrode is less than 2.11 g/cm³, based on a total weight of the iron and a total volume of the first electrode; an alkaline electrolyte; a second electrode; and an additive including a metal M, wherein the additive is effective to facilitate oxidation of the iron to Fe₃₋ₓMₓO₄, wherein 0≤x<1, optionally 0<x<1, and wherein a specific discharge capacity of the first electrode in a first discharge plateau is greater than 960 mAh/gram of iron, based on the total weight of iron in the first electrode.

Aspect 4. An electrochemical cell including: a first electrode including iron, wherein a density of the iron in the first electrode is less than 2.11 g/cm³, based on a total weight of the iron and a total volume of the first electrode, and wherein the first electrode includes Fe₃₋ₓMₓO₄, wherein M is a metal and 0≤x<1, optionally 0<x<1; an alkaline electrolyte; and a second electrode, wherein a specific discharge capacity of the first electrode in a first discharge plateau of the electrochemical cell is greater than 960 mAh/gram of iron, based on a total weight of iron in the first electrode.

Aspect 5. A method of operating an electrochemical cell, the method including: providing an electrochemical cell including a first electrode including iron, an alkaline electrolyte, and a second electrode, wherein the alkaline electrolyte, the first electrode, or a combination thereof includes an additive including M wherein M is a metal, the additive effective to facilitate oxidation of the iron to Fe₃₋ₓMₓO₄, wherein 0<x<1, optionally 0≤x<1, on a first discharge plateau; discharging the electrochemical cell at a C rate of less than C/12, preferably C/150 to C/12, to oxidize the iron and form the Fe₃₋ₓMₓO₄ wherein 0≤x<1; and charging the electrochemical cell to operate the electrochemical cell.

Aspect 6. A method of operating an electrochemical cell, the method including: providing the electrochemical cell including a first electrode including iron, an alkaline electrolyte, and a second electrode, wherein the alkaline electrolyte, the first electrode, or a combination thereof includes an additive including M, wherein M is a metal; discharging the electrochemical cell at a C rate of less than C/12, preferably C/150 to C/12, to concurrently oxidize the iron to iron (II) hydroxide and the iron (II) hydroxide to Fe₃₋ₓMₓO₄ wherein 0≤x<1, optionally 0<x<1, on a first discharge plateau; and charging the electrochemical cell to operate the electrochemical cell.

Aspect 7. An electrochemical method to produce a tin-iron compound, the method comprising: providing an electrochemical cell comprising a first electrode comprising iron, an alkaline electrolyte, a second electrode, and an additive comprising tin; and discharging the electrochemical cell to oxidize the iron of the first electrode and produce the tin-iron compound, wherein the tin-iron compound comprises tin, iron, and oxygen, and the tin-iron compound has a formula of Fe₃₋ₓSnₓO₄, wherein 0.01≤x<1.

Aspect 8. A tin-iron compound prepared by the method comprising: providing an electrochemical cell comprising a first electrode comprising iron, an alkaline electrolyte, a second electrode, and an additive comprising tin; and discharging the electrochemical cell to oxidize the iron of the first electrode and produce the tin-iron compound, wherein the tin-iron compound comprises tin, iron, and oxygen, and the tin-iron compound has a formula of Fe₃₋ₓSnₓO₄, wherein 0.01<x≤1.

Aspect 9. A negative electrode for an alkaline electrochemical cell, the negative electrode comprising: a current collector; and a negative electrode active material layer comprising a negative electrode active material on the current collector, wherein the negative electrode active material comprises a tin-iron compound comprising tin, iron, and oxygen, and the tin-iron compound has a formula of Fe₃₋ₓSnₓO₄, wherein 0.01<x≤1.

Aspect 10. An electrochemical cell comprising: the negative electrode of aspect 9; an alkaline electrolyte; and a positive electrode.

Aspect 11. A battery comprising the electrochemical cell of aspect 10.

Aspect 12. A device comprising the battery of aspect 11.

Aspect 13. A system comprising the battery of aspect 11.

Aspect 14. A power grid comprising the battery of aspect 11.

Aspect 15. An electrochemical cell, comprising: a first electrode comprising iron; an alkaline electrolyte; a second electrode; and a tin-iron compound, wherein the tin-iron compound comprises tin, iron, and oxygen, and the tin-iron compound has a formula of Fe₃₋ₓSnₓO₄, wherein 0.01<x≤1.

Aspect 16. A method of operating an electrochemical cell, the method comprising: providing the electrochemical cell comprising: a first electrode comprising iron, an alkaline electrolyte, a second electrode, and an additive comprising tin; discharging the electrochemical cell to oxidize the iron of the first electrode and produce a tin-iron compound, wherein the tin-iron compound has a formula of Fe₃₋ₓSnₓO₄, wherein 0.01<x≤1; and charging the electrochemical cell to convert at least a portion of the tin-iron compound to iron metal.

Aspect 17. An electrochemical method of producing a tin-iron compound, the method comprising: providing an electrochemical cell comprising: a first electrode comprising iron, an alkaline electrolyte, a second electrode, and an additive comprising tin; and discharging the electrochemical cell to produce the tin-iron compound, wherein the tin-iron compound comprises tin, iron, and oxygen, and the tin-iron compound has a formula of Fe₃₋ₓSnₓO₄, wherein 0.01<x≤1.

Aspect 18. An electrochemical method to produce a tin-iron compound, the method comprising: providing an electrochemical cell comprising: a first electrode comprising iron, an alkaline electrolyte, a second electrode, and an additive comprising tin having an oxidation state of 0, +2, +4, or a combination thereof; and discharging the electrochemical cell to produce the tin-iron compound, wherein the tin-iron compound comprises a tin-doped magnetite, the tin-doped magnetite has a cubic unit cell having a lattice parameter of greater than 8.399 Angstroms at room temperature, preferably from 8.410 to 8.595 Angstroms.

In any of the foregoing aspects, wherein the iron in the first electrode comprises iron having an oxidation state of 0, 2+, 3+, or a combination thereof, provided that the iron is not entirely in a form of Fe₃O₄;
wherein the density (D) of the iron in the first electrode is less than 3.74 gram/cm³, based on the total weight of the iron and the total volume of the first electrode,
the specific discharge capacity (Q) of the first electrode is less than 1280 mAh/gram of iron, based on the total weight of iron in the first electrode, and the specific discharge capacity (Q) of the first electrode is greater than ((7.87/D)−1)*352 mAh/gram of iron in the first electrode, based on the total weight of iron in the first electrode;
wherein the density of iron (D) in the first electrode is less than 3.74 gram/cm³, based on the total weight of iron and the total volume of the first electrode, and the specific discharge capacity (Q) of the first electrode is less than ((7.87/D)−1)*1158.4 mAh/gram of iron in the first electrode, and greater than ((7.87/D)−1)*352 mAh/gram of iron in the first electrode;
wherein the additive is in the alkaline electrolyte, the first electrode, or a combination thereof;
wherein the specific discharge capacity of the first electrode and based on the weight of iron in the first electrode is at least 90% of a total specific discharge capacity of the first electrode; wherein the metal M is Sn, Mo, W, Nb, Ta, Ge, Pb, Bi, Sb, Ti, Al, Zn, or a combination thereof, preferably wherein the metal M is Sn;
when the alkaline electrolyte comprises the additive, optionally a content of the additive in the alkaline electrolyte is 0.1 to 200 millimolar, based on a total volume of the alkaline electrolyte, or when the first electrode comprises the additive, optionally a content of the additive in the first electrode is 0.5 to 25 weight percent based on a total volume of the first electrode;
wherein the Fe₃₋ₓMₓO₄ is reversibly reducible to metallic iron and an M-containing species when M is present upon charging the electrochemical cell;
wherein the Fe₃₋ₓMₓO₄ is disposed in a pore of the first electrode;
wherein the alkaline electrolyte, the first electrode, or a combination thereof further comprise an additive comprising the M, wherein the M is a metal effective to facilitate oxidation of the iron in the first electrode to Fe₃₋ₓMₓO₄;
wherein the Fe₃₋ₓMₓO₄ is an oxidation product of the iron in the first electrode, formed on discharge of the electrochemical cell;
wherein the specific discharge capacity of the first electrode in the first discharge plateau is greater than 960 mAh/gram of iron, and less than 1280 mAh/gram of iron, based on the total weight of iron in the first electrode, wherein when discharged, the first electrode comprises a discharge product comprising the Fe₃₋ₓMₓO₄, wherein the C rate is obtained by dividing a discharge capacity of the electrochemical cell on a first cycle by a discharge time in hours;
wherein a density of the iron in the first electrode is less than 2.11 g/cm³, based on a total weight of the iron and a total volume of the first electrode, and the first electrode has a specific discharge capacity (Q) on a first discharge plateau according to Formula 1:

Q>(V1/V2)*352 mAh/gram of iron, based on the total weight of the iron in the first electrode (1),
wherein V1 is a void volume of the first electrode and V2 is a metallic volume of the first electrode in a fully reduced state;
wherein a density of the iron in the first electrode is less than 2.11 g/cm³, based on a total weight of the iron and a total volume of the first electrode, and the first electrode has a specific discharge capacity on the first discharge plateau of greater than 960 mAh/gram of iron, based on a total weight of the iron in the first electrode;
wherein the electrochemical cell is an iron-air cell, and the discharging is at a C rate of C/150 to C/36;
wherein the electrochemical cell is an iron-manganese oxide cell, and the discharging is at a C rate of C/150 to C/12;
wherein a specific discharge capacity of the first electrode is greater than a theoretical specific discharge capacity of the first electrode when the theoretical specific discharge capacity is determined based on an assumption of 100% filling of a pore in the first electrode by Fe(OH)₂;
wherein the alkaline electrolyte may have a total alkalinity of greater than 3 molar, preferably 3 to 12 molar, more preferably 4.5 to 8 molar;
the first electrode further may comprise the tin-iron compound;
the tin-iron compound may be disposed within the first electrode;
the tin-iron compound may be a tin-doped magnetite;
the tin-iron compound may have a cubic unit cell having a lattice parameter of greater than 8.399 Angstroms at room temperature, preferably from 8.410 to 8.595 Angstroms;
the tin-iron compound may have a peak centered at 17.420 to 18.254 °2θ, when analyzed by X-ray diffraction using Cu Kα radiation;
the tin-iron compound may be in a form of a particle having an average particle size of less than 100 micrometers, and optionally having a spherical, platelet, or needle-like shape;
the first electrode may further comprise a tin-doped magnetite, and the tin-doped magnetite may have a tin content of 0.5 to 25 wt %, based on a total weight of the first electrode; or 0.5 to 25 wt %, based on a total weight of the tin-doped magnetite;
the first electrode may be a working electrode, and the second electrode may be a counter electrode;
the alkaline electrolyte may comprise the tin-iron compound, and the tin-iron compound may have a peak centered at 17.420 to 18.254 °2θ, when analyzed by X-ray diffraction using Cu Kα radiation;
the oxidizing may comprise forming magnetite, incorporating tin into magnetite, forming the tin-iron compound, or a combination thereof;
the tin-iron compound may be isostructural with magnetite;
the tin-iron compound may have a formula of Fe₃₋ₓSnₓO₄, wherein 0.01<x≤1;
the additive may comprises sodium stannate, potassium stannate, sodium stannate trihydrate, metallic tin, potassium stannate trihydrate, tin (II) oxide, tin (IV) oxide, cylindrite, copper iron tin sulfide, a lead-tin alloy, a zinc-tin alloy, iron tin oxide, tin sulfide, SnCl₂, tin sulfate, or a combination thereof, preferably, sodium stannate, potassium stannate, or a combination thereof;
the additive may comprise tin having an oxidation state of 0, +2, +4, or a combination thereof; the alkaline electrolyte may comprise lithium hydroxide, sodium hydroxide, potassium hydroxide, cesium hydroxide, or a combination thereof, preferably potassium hydroxide;
the first electrode, the alkaline electrolyte, or a combination thereof may further comprise a sulfide-containing compound;
the sulfide-containing compound may comprise iron sulfide, iron disulfide, iron-copper sulfide, zinc sulfide, manganese sulfide, tin sulfide, copper sulfide, cadmium sulfide, silver sulfide, titanium disulfide, lead sulfide, molybdenum sulfide, nickel sulfide, antimony sulfide, lithium sulfide, selenium sulfide, mercury sulfide, polysulfide salts, or a combination thereof, preferably zinc sulfide, sodium sulfide, potassium sulfide, or a combination thereof;
the tin-iron compound may have a formula of Fe₃₋ₓSnₓO₄, wherein 0.01<x≤1;
wherein the negative electrode active material further comprises iron, and wherein a ratio of the tin-iron compound to iron in the negative electrode active material layer may be greater on a surface of the negative electrode active material layer opposite the current collector than on a surface of the negative electrode active material layer adjacent the current collector;
the tin-iron compound may have a tin content of: 0.5 to 25 wt %, based on a total weight of the negative electrode; or 0.5 to 25 wt %, based on a total weight of the tin-iron compound;
the first electrode may further comprise the additive, and an amount of the additive in the first electrode is 0.1 to 40 wt %, based on a total weight of the first electrode;
the alkaline electrolyte may comprise the additive, and an amount of the additive in the alkaline electrolyte is 0.1 to 200 mM based on a total volume of the alkaline electrolyte;
wherein the method may further comprise a second discharge cycle of discharging the electrochemical cell to produce the tin-iron compound;
wherein the method comprises incorporating tin into magnetite, forming the tin-iron compound, or a combination thereof, and the charging may comprise converting the magnetite, the tin-iron compound, or a combination thereof, to iron metal; or
wherein the charging of the electrochemical cell to convert the magnetite, the tin-iron compound, or a combination thereof, to the iron metal may comprise converting 95-100%, preferably 98-100%, of the magnetite to the iron metal, based on a total weight of the magnetite, converting 95-100%, preferably 98-100%, of the tin-iron compound to the iron metal, based on a total weight of the tin-iron compound, or a combination thereof.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. For example, “an element” has the same meaning as “at least one element,” unless the context clearly indicates otherwise. Thus, reference to “an” element in a claim followed by reference to “the” element is inclusive of one element and a plurality of the elements.

“Or” means “and/or” unless clearly stated otherwise. Reference throughout the specification to “some embodiments,” “an embodiment,” “an aspect,” and so forth, means that a particular element described in connection with the embodiment and/or aspect is included in at least one embodiment and/or aspect described herein, and may or may not be present in other embodiments and/or aspects. In addition, it is to be understood that the described elements may be combined in any suitable manner in the various embodiments and/or aspects. A “combination thereof” is open and includes any combination comprising at least one of the listed components or properties optionally together with a like or equivalent component or property not listed.

The terms “comprises” and/or “comprising,” or “includes” and/or “including” or “contains” and/or “containing” when used in this specification, specify the presence of stated features, regions, integers, steps, operations, elements, and/or components, but do not preclude the presence or addition of one or more other features, regions, integers, steps, operations, elements, components, and/or groups thereof.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. An electrochemical cell comprising:
a first electrode comprising iron, wherein a density (D) of the iron in the first electrode is greater than 2.11 g/cm³ and less than 7.87 g/cm³, based on a total weight of the iron and a total volume of the first electrode;
an alkaline electrolyte;
a second electrode; and
an additive comprising a metal M, wherein the additive is effective to facilitate oxidation of the iron to Fe₃₋ₓMₓO₄, wherein 0≤x<1, optionally 0<x<1, and
wherein a specific discharge capacity (Q) of the first electrode in a first discharge plateau is represented by Formula 1
Q>((7.87/D)−1)*352 mAh/gram of iron, based on the total weight of iron in the first electrode (1).

2. The electrochemical cell of claim 1, wherein the iron is not entirely in a form of Fe₃O₄.

3. The electrochemical cell of claim 1, wherein
the density (D) of the iron in the first electrode is less than 3.74 gram/cm³, based on the total weight of the iron and the total volume of the first electrode,
the specific discharge capacity (Q) of the first electrode in the first discharge plateau is less than 1280 mAh/gram of iron, based on the total weight of iron in the first electrode, and
the specific discharge capacity (Q) of the first electrode in the first discharge plateau is greater than
((7.87/D)−1)*352 mAh/gram of iron, based on the total weight of iron in the first electrode.

4. The electrochemical cell of claim 1, wherein
the density of iron (D) in the first electrode is less than 3.74 gram/cm³, based on the total weight of iron and the total volume of the first electrode, and
the specific discharge capacity (Q) of the first electrode in the first discharge plateau is
less than ((7.87/D)−1)*1158.4 mAh/gram of iron, based on the total weight of iron in the first electrode, and
greater than ((7.87/D)−1)*352 mAh/gram of iron, based on the total weight of iron in the first electrode.

5. The electrochemical cell of claim 1,
wherein the additive is in the alkaline electrolyte, the first electrode, or a combination thereof, and wherein the metal M is Sn, Mo, W, Nb, Ta, Ge, Pb, Bi, Sb, Ti, Al, Zn, or a combination thereof, and
optionally wherein when the alkaline electrolyte comprises the additive, a content of the additive in the alkaline electrolyte is 0.1 to 200 millimolar, based on a total volume of the alkaline electrolyte, or
optionally wherein when the first electrode comprises the additive, a content of the additive in the first electrode is 0.5 to 25 weight percent based on a total volume of the first electrode.

6. The electrochemical cell of claim 1,
wherein the specific discharge capacity of the first electrode and based on the weight of iron in the first electrode is at least 90% of a total specific discharge capacity of the first electrode.

7. The electrochemical cell of claim 1, wherein the Fe₃₋ₓMₓO₄ is disposed in a pore of the first electrode, and wherein the Fe^{3-x}MₓO₄ is reversibly reducible to metallic iron and an M-containing species when M is present upon charging the electrochemical cell.

8. An electrochemical cell comprising:
a first electrode comprising iron,
wherein a density (D) of the iron in the first electrode is greater than 2.11 g/cm³ and less than 7.87 g/cm³, based on a total weight of iron and a total volume of the first electrode;
wherein the first electrode comprises Fe₃₋ₓMₓO₄, wherein M is a metal and 0≤x<1, optionally 0<x<1;
an alkaline electrolyte;
a second electrode; and
wherein a specific discharge capacity (Q) of a first electrode in a first discharge plateau is represented by Formula 1
Q>((7.87/D)−1)*352 mAh/gram of iron, based on the total weight of iron in the first electrode (1).

9. The electrochemical cell of claim 8,
wherein the M is a metal effective to facilitate oxidation of the iron in the first electrode to Fe₃₋ₓMₓO₄, wherein the metal M is Sn, Mo, W, Nb, Ta, Ge, Pb, Bi, Sb, Ti, Al, Zn, or a combination thereof, and
wherein the alkaline electrolyte, the first electrode, or a combination thereof further comprise an additive comprising the M, and
optionally wherein when the alkaline electrolyte comprises the additive, a content of the additive in the alkaline electrolyte is 0.1 to 200 millimolar, based on a total volume of the alkaline electrolyte, or
optionally wherein when the first electrode comprises the additive, a content of the additive in the first electrode is 0.5 to 25 weight percent based on a total volume of the first electrode.

10. The electrochemical cell of claim 8, wherein the Fe₃₋ₓMₓO₄ is an oxidation product of the iron in the first electrode, formed on discharge of the electrochemical cell.

11. The electrochemical cell of claim 8,
wherein the density of iron (D) in the first electrode is greater than 2.11 g/cm³ and less than 3.74 gram/cm³, based on the total weight of the iron and the total volume of the first electrode, and
wherein the specific discharge capacity (Q) of the first electrode in the first discharge plateau, based on the total weight of iron in the first electrode is:
less than 1280 mAh/gram of iron in the first electrode, or
less than ((7.87/D)−1)*1158.4 mAh/gram of iron in the first electrode; and
greater than ((7.87/D)−1)*352 mAh/gram of iron in the first electrode.

12. The electrochemical cell of claim 8,
wherein the specific discharge capacity of the first electrode in the first discharge plateau and based on the weight of iron in the first electrode is at least 90% of a total specific discharge capacity of the first electrode.

13. The electrochemical cell of claim 8, wherein the Fe₃₋ₓMₓO₄ is disposed in a pore of the first electrode, and wherein the Fe₃₋ₓMₓO₄ is reversibly reducible to metallic iron and an M-containing species when M is present upon charging the electrochemical cell.

14. An electrochemical cell comprising:
a first electrode comprising iron, wherein a density of the iron in the first electrode is less than 2.11 g/cm³, based on a total weight of the iron and a total volume of the first electrode;
an alkaline electrolyte;
a second electrode; and
an additive comprising a metal M, wherein the additive is effective to facilitate oxidation of the iron to Fe₃₋ₓMₓO₄, wherein 0≤x<1, optionally 0<x<1, and
wherein a specific discharge capacity of the first electrode in the first discharge plateau is greater than 960 mAh/gram of iron, based on the total weight of iron in the first electrode.

15. The electrochemical cell of claim 14, wherein the iron is not entirely in a form of Fe₃O₄.

16. The electrochemical cell of claim 14, wherein the specific discharge capacity of the first electrode in the first discharge plateau is greater than 960 mAh/gram of iron, and less than 1280 mAh/gram of iron, based on the total weight of iron in the first electrode.

17. The electrochemical cell of claim 14,
wherein the additive is in the alkaline electrolyte, the first electrode, or a combination thereof, and wherein the metal M is Sn, Mo, W, Nb, Ta, Ge, Pb, Bi, Sb, Ti, Al, Zn, or a combination thereof, and
optionally wherein when the alkaline electrolyte comprises the additive, a content of the additive in the alkaline electrolyte is 0.1 to 200 millimolar, based on a total volume of the alkaline electrolyte, or
optionally wherein when the first electrode comprises the additive, a content of the additive in the first electrode is 0.5 to 25 weight percent based on a total volume of the first electrode.

18. The electrochemical cell of claim 14,
wherein the specific discharge capacity of the first electrode in the first discharge plateau and based on a weight of the iron in the first electrode is at least 90% of a total specific discharge capacity of the first electrode.

19. The electrochemical cell of claim 14,
wherein when discharged, the first electrode comprises a discharge product comprising the Fe₃₋ₓMₓO₄,
wherein the Fe₃₋ₓMₓO₄ is disposed in a pore of the first electrode, and
wherein the Fe₃₋ₓMₓO₄ is reversibly reducible to metallic iron and an M-containing species when M is present upon charging the electrochemical cell.

20. An electrochemical cell comprising:
a first electrode comprising iron,
wherein a density of the iron in the first electrode is less than 2.11 g/cm³, based on a total weight of the iron and a total volume of the first electrode, and
wherein the first electrode comprises Fe₃₋ₓMₓO₄, wherein M is a metal and 0≤x<1, optionally 0<x<1;
an alkaline electrolyte; and
a second electrode,
wherein a specific discharge capacity of the first electrode in a first discharge plateau is greater than 960 mAh/gram of iron, based on a total weight of iron in the first electrode.

21. The electrochemical cell of claim 20, wherein the specific discharge capacity of the first electrode in the first discharge plateau is less than 1280 mAh/gram of iron, based on the total weight of iron in the first electrode.

22. The electrochemical cell of claim 20,
wherein the M is a metal effective to facilitate oxidation of the iron to Fe₃₋ₓMₓO₄,
wherein the metal M is Sn, Mo, W, Nb, Ta, Ge, Pb, Bi, Sb, Ti, Al, Zn, or a combination thereof, and
optionally wherein the alkaline electrolyte, the first electrode, or a combination thereof further comprise an additive comprising the M, and
optionally wherein when the alkaline electrolyte comprises the additive, a content of the additive in the alkaline electrolyte is 0.1 to 200 millimolar, based on a total volume of the alkaline electrolyte, or
optionally wherein when the first electrode comprises the additive, a content of the additive in the first electrode is 0.5 to 25 weight percent based on a total volume of the first electrode.

23. The electrochemical cell of claim 20,
wherein the Fe₃₋ₓMₓO₄ is an oxidation product of the iron in the first electrode, formed on discharge of the electrochemical cell,
wherein the Fe₃₋ₓMₓO₄ is disposed in a pore of the first electrode, and
wherein the Fe₃₋ₓMₓO₄ is reversibly reducible to metallic iron of the first electrode and an M-containing species when M is present upon charging the electrochemical cell.

24. The electrochemical cell of claim 20,
wherein the specific discharge capacity of the first electrode in the first discharge plateau and based on a weight of the iron in the first electrode is at least 90% of a total specific discharge capacity of the first electrode.

25. A method of operating an electrochemical cell, the method comprising:
providing an electrochemical cell comprising
a first electrode comprising iron,
an alkaline electrolyte, and
a second electrode,
wherein the alkaline electrolyte, the first electrode, or a combination thereof comprises an additive comprising M wherein M is a metal, the additive effective to facilitate oxidation of the iron to Fe₃₋ₓMₓO₄, wherein 0≤x<1, optionally 0≤x<1, on a first discharge plateau;
discharging the electrochemical cell at a C rate of less than C/12 to oxidize the iron and form the Fe₃₋ₓMₓO₄ wherein 0≤x<1; and
charging the electrochemical cell to operate the electrochemical cell.

26. The method of claim 25, wherein the iron is not entirely in a form of Fe₃O₄.

27. The method of claim 25, wherein the C rate is obtained by dividing a discharge capacity of the electrochemical cell on a first cycle by a discharge time in hours.

28. The method of claim 25, wherein M is a metal comprising Sn, Mo, W, Nb, Ta, Ge, Pb, Bi, Sb, Ti, Al, Zn, or a combination thereof, and
optionally wherein when the alkaline electrolyte comprises the additive, a content of the additive in the alkaline electrolyte is 0.1 to 200 millimolar, based on a total volume of the alkaline electrolyte, or
optionally wherein when the first electrode comprises the additive, a content of the additive in the first electrode is 0.5 to 25 weight percent based on a total volume of the first electrode.

29. The method of claim 25, wherein the Fe₃₋ₓMₓO₄ is disposed in a pore of the first electrode, wherein the Fe₃₋ₓMₓO₄ is reversibly reducible to metallic iron in the first electrode and an M-containing species when M is present upon charging the electrochemical cell.

30. The method of claim 25, wherein a density of the iron in the first electrode is less than 2.11 g/cm³, based on a total weight of the iron and a total volume of the first electrode, and
the first electrode has a specific discharge capacity (Q) on a first discharge plateau of greater than 960 mAh/gram of iron, based on a total weight of the iron in the first electrode.

31. The method of claim 25, wherein a density of the iron in the first electrode is less than 2.11 g/cm³, based on a total weight of the iron and a total volume of the first electrode, and
the first electrode has a specific discharge capacity on the first discharge plateau of greater than 960 mAh/gram of iron and less than 1280 mAh/gram of iron, based on a total weight of the iron in the first electrode.

32. The method of claim 25, wherein the electrochemical cell is an iron-air cell, and the discharging is at a C rate of C/150 to C/36, or
wherein the electrochemical cell is an iron-manganese oxide cell, and the discharging is at a C rate of C/150 to C/12.

33. The method of claim 25, wherein a specific discharge capacity of the first electrode is greater than a theoretical specific discharge capacity of the first electrode when the theoretical specific discharge capacity is determined based on an assumption of 100% filling of a pore in the first electrode by Fe(OH)₂.

34. A method of operating an electrochemical cell, the method comprising:
providing the electrochemical cell comprising
a first electrode comprising iron,
an alkaline electrolyte, and
a second electrode,
wherein the alkaline electrolyte, the first electrode, or a combination thereof comprises an additive comprising M, wherein M is a metal;
discharging the electrochemical cell at a C rate of less than C/12 to concurrently oxidize the iron to iron (II) hydroxide and the iron (II) hydroxide to Fe₃₋ₓMₓO₄ wherein 0≤x<1, optionally 0<x<1, on a first discharge plateau; and
charging the electrochemical cell to operate the electrochemical cell.

35. The method of claim 34, wherein the iron is not entirely in a form of Fe₃O₄.

36. The method of claim 34, wherein the C rate is obtained by dividing a discharge capacity of the electrochemical cell on a first cycle by a discharge period in hours.

37. The method of claim 34, wherein M is a metal comprising Sn, Mo, W, Nb, Ta, Ge, Pb, Bi, Sb, Ti, Al, Zn, or a combination thereof, and
optionally wherein when the alkaline electrolyte comprises the additive, a content of the additive in the alkaline electrolyte is 0.1 to 200 millimolar, based on a total volume of the alkaline electrolyte, or
optionally wherein when the first electrode comprises the additive, a content of the additive in the first electrode is 0.5 to 25 weight percent based on a total volume of the first electrode.

38. The method of claim 34, wherein the Fe₃₋ₓMₓO₄ is disposed in a pore of the first electrode, and the Fe₃₋ₓMₓO₄ is reversibly reducible to the iron and an M-containing species when M is present upon charging the electrochemical cell.

39. The method of claim 34, wherein a density of the iron in the first electrode is less than 2.11 g/cm³, based on a total weight of the iron and a total volume of the first electrode, and
the first electrode has a specific discharge capacity (Q) on a first discharge plateau of greater than 960 mAh/gram of iron, based on a total weight of the iron in the first electrode.

40. The method of claim 34, wherein a density of the iron in the first electrode is less than 2.11 g/cm³, based on a total weight of the iron and a total volume of the first electrode, and
the first electrode has a specific discharge capacity on the first discharge plateau of greater than 960 mAh/gram of iron and less than 1280 mAh/gram of iron, based on a total weight of the iron in the first electrode.

41. The method of claim 34,
wherein the electrochemical cell is an iron-air cell, and the discharging is at a C rate of C/150 to C/36, or
wherein the electrochemical cell is an iron-manganese oxide cell and the discharging is at a C rate of C/150 to C/12.

42. The method of claim 34, wherein a specific discharge capacity of the first electrode is greater than a theoretical specific discharge capacity of the first electrode when the theoretical specific discharge capacity is determined based on an assumption of 100% filling of a pore in the first electrode by Fe(OH)₂.

43. An electrochemical method to produce a tin-iron compound, the method comprising:
providing an electrochemical cell comprising:
a first electrode comprising iron,
an alkaline electrolyte,
a second electrode, and
an additive comprising tin; and
discharging the electrochemical cell to oxidize the iron of the first electrode and produce the tin-iron compound, wherein the tin-iron compound comprises tin, iron, and oxygen, and the tin-iron compound has a formula of Fe₃₋ₓSnₓO₄, wherein 0.01<x≤1.

44. The electrochemical method of claim 43, wherein the alkaline electrolyte has a total alkalinity of greater than 3 molar.

45. The electrochemical method of claim 43, wherein the first electrode further comprises the tin-iron compound, optionally wherein the tin-iron compound is disposed within the first electrode.

46. The electrochemical method of claim 43, wherein the tin-iron compound has a cubic unit cell having a lattice parameter of greater than 8.399 Angstroms at room temperature.

47. The electrochemical method of claim 43, wherein the tin-iron compound has a peak centered at 17.420 to 18.254 °2θ, when analyzed by X-ray diffraction using Cu Kα radiation.

48. The electrochemical method of claim 43, wherein the tin-iron compound is in a form of a particle having an average particle size of less than 100 micrometers, and optionally having a spherical, platelet, or needle-like shape.

49. The electrochemical method of claim 43, wherein the first electrode further comprises the tin-iron compound, and the tin-iron compound has a tin content of:
0.5 to 25 wt %, based on a total weight of the first electrode;
0.5 to 25 wt %, based on a total weight of the tin-doped magnetite, or
a combination thereof.

50. The electrochemical method of claim 43, wherein the first electrode is a working electrode, and the second electrode is a counter electrode.

51. The electrochemical method of claim 43, wherein the alkaline electrolyte comprises the tin-iron compound, and wherein the tin-iron compound has a peak centered at 17.420 to 18.254 °2θ, when analyzed by X-ray diffraction using Cu Kα radiation.

52. The electrochemical method of claim 43, wherein the oxidizing comprises forming magnetite, incorporating tin into magnetite, forming the tin-iron compound, or a combination thereof.

53. The electrochemical method of claim 43, wherein the tin-iron compound is isostructural with magnetite.

54. The electrochemical method of claim 43, wherein the additive comprises sodium stannate, potassium stannate, sodium stannate trihydrate, metallic tin, potassium stannate trihydrate, tin (II) oxide, tin (IV) oxide, cylindrite, copper iron tin sulfide, a lead-tin alloy, a zinc-tin alloy, iron tin oxide, tin sulfide, SnCl₂, tin sulfate, or a combination thereof.

55. The electrochemical method of claim 43, wherein the additive comprises tin having an oxidation state of 0, +2, +4, or a combination thereof.

56. The electrochemical method of claim 43, wherein the additive is contained in the first electrode, the alkaline electrolyte, or a combination thereof.

57. The electrochemical method of claim 43, wherein
the first electrode further comprises the additive; and
an amount of the additive in the first electrode is 0.5 to 25 wt %, based on a total weight of the first electrode.

58. The electrochemical method of claim 43, wherein
the alkaline electrolyte comprises the additive; and
an amount of the additive in the alkaline electrolyte is 0.1 to 200 millimolar, based on a total volume of the alkaline electrolyte.

59. The electrochemical method of claim 43, wherein the alkaline electrolyte comprises lithium hydroxide, sodium hydroxide, potassium hydroxide, cesium hydroxide, or a combination thereof.

60. The electrochemical method of claim 43, wherein the first electrode, the alkaline electrolyte, or a combination thereof further comprises a sulfide-containing compound, optionally wherein the sulfide-containing compound comprises iron sulfide, iron disulfide, iron-copper sulfide, zinc sulfide, manganese sulfide, tin sulfide, copper sulfide, cadmium sulfide, silver sulfide, titanium disulfide, lead sulfide, molybdenum sulfide, nickel sulfide, antimony sulfide, lithium sulfide, selenium sulfide, mercury sulfide, polysulfide salts, or a combination thereof.

61. A tin-iron compound prepared by the method of claim 43.

62. The tin-iron compound of claim 61, wherein the tin-iron compound has a cubic unit cell having a lattice parameter of greater than 8.399 Angstroms at room temperature, and wherein the tin-iron compound is isostructural with magnetite.

63. A negative electrode for an alkaline electrochemical cell, the negative electrode comprising:
a current collector; and
a negative electrode active material layer comprising a negative electrode active material on the current collector,
wherein the negative electrode active material comprises a tin-iron compound comprising tin, iron, and oxygen, and the tin-iron compound has a formula of Fe₃₋ₓSnₓO₄, wherein 0.01<x≤1.

64. The negative electrode of claim 63, wherein the negative electrode active material further comprises iron, and wherein a ratio of the tin-iron compound to iron in the negative electrode active material layer is greater on a surface of the negative electrode active material layer opposite the current collector than on a surface of the negative electrode active material layer adjacent the current collector.

65. The negative electrode of claim 63,
wherein the tin-iron compound is in a form of a particle having a spherical, platelet, or needle-like shape, and has an average particle size of less than 100 micrometers.

66. The negative electrode of claim 63, wherein the tin-iron compound has a cubic unit cell having a lattice parameter of greater than 8.399 Angstroms at room temperature, and wherein the tin-iron compound is isostructural with magnetite.

67. The negative electrode of claim 63, wherein the tin-iron compound has a tin content of:
0.5 to 25 wt %, based on a total weight of the negative electrode;
0.5 to 25 wt %, based on a total weight of the tin-iron compound, or
a combination thereof.

68. The negative electrode of claim 63, wherein the tin-iron compound has a peak centered at 17.420 to 18.254 °2θ, when analyzed by X-ray diffraction using Cu Kα radiation.

69. An electrochemical cell comprising:
the negative electrode of claim 63;
an alkaline electrolyte; and
a positive electrode.

70. A battery comprising the electrochemical cell of claim 69.

71. A system comprising the battery of claim 70.

72. A power grid comprising the battery of claim 70.

73. An electrochemical cell, comprising:
a first electrode comprising iron;
an alkaline electrolyte;
a second electrode; and
a tin-iron compound,
wherein the tin-iron compound comprises tin, iron, and oxygen, and the tin-iron compound has a formula of Fe₃₋ₓSnₓO₄, wherein 0.01<x≤1.

74. The electrochemical cell of claim 73, wherein the tin-iron compound is a product of oxidizing the iron of the first electrode in the presence of an additive comprising tin.

75. The electrochemical cell of claim 73, wherein the alkaline electrolyte has a total alkalinity of greater than 3 molar.

76. The electrochemical cell of claim 73, wherein the first electrode comprises the tin-iron compound, optionally wherein the tin-iron compound has a tin content of:
0.5 to 25 wt %, based on a total weight of the first electrode;
0.5 to 25 wt %, based on a total weight of the tin-iron compound; or
both.

77. The electrochemical cell of claim 73,
wherein the tin-iron compound has a cubic unit cell having a lattice parameter of greater than 8.399 Angstroms at room temperature,
wherein the tin-iron compound is isostructural with magnetite,
wherein the tin-iron compound has a peak centered at 17.420 to 18.254 °2θ, when analyzed by X-ray diffraction using Cu Kα radiation, or
a combination thereof.

78. The electrochemical cell of claim 73, wherein the tin-iron compound is in a form of a particle having an average particle size of less than 100 micrometers, and optionally having a spherical, platelet, or needle-like shape.

79. The electrochemical cell of claim 73, wherein the first electrode is a working electrode, and the second electrode is a counter electrode.

80. The electrochemical cell of claim 73, further comprising an additive comprising tin, optionally wherein the additive is contained in the first electrode, the alkaline electrolyte, or a combination thereof.

81. The electrochemical cell of claim 80, wherein the additive comprises tin having an oxidation state of 0, +2, +4, or a combination thereof, optionally wherein the additive comprises sodium stannate, potassium stannate, sodium stannate trihydrate, metallic tin, potassium stannate trihydrate, tin (II) oxide, tin (IV) oxide, cylindrite, copper iron tin sulfide, a lead-tin alloy, a zinc-tin alloy, iron tin oxide, tin sulfide, SnCl₂, tin sulfate, or a combination thereof.

82. The electrochemical cell of claim 80, wherein
the first electrode further comprises the additive; and
an amount of the additive in the first electrode is 0.1 to 40 wt %, based on a total weight of the first electrode.

83. The electrochemical cell of claim 80, wherein
the alkaline electrolyte comprises the additive; and
an amount of the additive in the alkaline electrolyte is 0.1 to 200 millimolar, based on a total volume of the alkaline electrolyte.

84. The electrochemical cell of claim 73, wherein the alkaline electrolyte comprises lithium hydroxide, sodium hydroxide, potassium hydroxide, cesium hydroxide, or a combination thereof.

85. The electrochemical cell of claim 73, wherein the first electrode, the alkaline electrolyte, or a combination thereof further comprises a sulfide-containing compound, optionally wherein the sulfide-containing compound comprises iron sulfide, iron disulfide, iron-copper sulfide, zinc sulfide, manganese sulfide, tin sulfide, copper sulfide, cadmium sulfide, silver sulfide, titanium disulfide, lead sulfide, molybdenum sulfide, nickel sulfide, antimony sulfide, lithium sulfide, selenium sulfide, mercury sulfide, polysulfide salts, or a combination thereof.

86. A method of operating an electrochemical cell, the method comprising:
providing the electrochemical cell comprising:
a first electrode comprising iron,
an alkaline electrolyte,
a second electrode, and
an additive comprising tin, wherein the additive is contained in at least one of the first electrode, the alkaline electrolyte, or the second electrode;
discharging the electrochemical cell to oxidize the iron of the first electrode and produce a tin-iron compound, wherein the tin-iron compound has a formula of Fe₃₋ₓSnₓO₄, wherein 0.01<x≤1; and
charging the electrochemical cell to convert at least a portion of the tin-iron compound to iron metal.

87. The method of claim 86, further comprising a second discharge cycle of discharging the electrochemical cell to produce the tin-iron compound.

88. The method of claim 86, wherein the alkaline electrolyte has a total alkalinity of greater than 3 molar.

89. The method of claim 86,
wherein the tin-iron compound has a cubic unit cell having a lattice parameter of greater than 8.399 Angstroms at 20° C., or
wherein the tin-iron compound has a peak centered at 17.420 to 18.254 °2θ, when analyzed by X-ray diffraction using Cu Kα radiation.

90. The method of claim 86, wherein the oxidizing the iron of the first electrode comprises forming magnetite, incorporating tin into magnetite, forming the tin-iron compound, or a combination thereof; and
the charging comprises converting the magnetite, the tin-iron compound, or a combination thereof, to iron metal.

91. The method of claim 90, wherein the charging of the electrochemical cell to convert the magnetite, the tin-iron compound, or a combination thereof, to the iron metal comprises
converting 95-100% of the magnetite to the iron metal, based on a total weight of the magnetite,
converting 95-100% of the tin-iron compound to the iron metal, based on a total weight of the tin-iron compound, or
a combination thereof.

92. An electrochemical method of producing a tin-iron compound, the method comprising:
providing an electrochemical cell comprising:
a first electrode comprising iron,
an alkaline electrolyte,
a second electrode, and
an additive comprising tin; and
discharging the electrochemical cell to produce the tin-iron compound, wherein the tin-iron compound comprises tin, iron, and oxygen, and the tin-iron compound has a formula of Fe₃₋ₓSnₓO₄, wherein 0.01<x≤1.

93. An electrochemical method to produce a tin-iron compound, the method comprising:
providing an electrochemical cell comprising:
a first electrode comprising iron,
an alkaline electrolyte,
a second electrode, and
an additive comprising tin having an oxidation state of 0, +2, +4, or a combination thereof; and
discharging the electrochemical cell to produce the tin-iron compound, wherein the tin-iron compound comprises a tin-doped magnetite, the tin-doped magnetite has a cubic unit cell having a lattice parameter of greater than 8.399 Angstroms at 20° C.
